(19) United States
(12) Patent Application Publication
(10) Pub. No.: US 2007/0239975 A1
(43) Pub. Date: Oct. 11, 2007

(54) Programmable backward jump instruction prediction mechanism

(76) Inventor: Lei Wang, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/500,298

(22) Filed: Aug. 8, 2006

(30) Foreign Application Priority Data
Apr. 7, 2006 (CN) 095112523

(51) Int. Cl. G06F 9/44

(52) U.S. Cl. 712/241

(57) ABSTRACT

A programmable backward jump instruction prediction mechanism includes a backward branch prediction queues (BBQ) for assisting an embedded processor to overcome an inevitable control hazard caused in a pipeline execution for a conditional branch instruction. A large percentage of nested loops exists in an application program executed by the embedded processor, and thus when the backward branch encounters a nested loop, the behavior of branch of a nested loop is similar to a queue that will automatically restore its original status; the whole nested loop iterates at a center and repeats the execution of innermost loops (Queue Front) and leaves the prediction miss to the next backward branch (an outer loop, Queue Next); once if an outer loop hits a branchy, the inner loop will repeat the branch ( and returns to the innermost loop Queue Front). Since the program counter (PC) and the branch address of the queue can be used for determining whether or not the program execution is still in a nested loop or whether or not a jump is from a backward branch by the target address of the branch instruction. It is only necessary to predict an execution and compare a specific branch address in the queue for each time, and thus the queue structure needs not to store too many instructions or quickly compare a large number of data by the associative memory technique. The hardware is very simple, but the effect is excellent. According to the simulation analysis of the application program, it is discovered that the average prediction accuracy is up to 82% and some applications may even have an accuracy of 99%. The hardware mechansim of the invention features a low cost and a low level of complexity, and thus fully satifying the requirements for low cost, low power consumption, and high performance/cost ratio of an embedded processor.

### BACKGROUND OF THE INVENTION

1. Field of the Invention

The present invention relates to a programmable backward jump instruction prediction mechanism, and more particularly to a design of a backward branch prediction queues (BBQ) prediction mechanism that integrates some adders, latches, counters and small-scale combination logics for specific pipeline operations of a processor and merges with the design of the original embedded processor to assist the microprocessor to solve the inevitable control hazard problem occurred in a pipeline execution of conditional branch instructions.

2. Description of the Related Art

In the present common branch prediction technologies, a branch target buffer (BTB) circuit is added into the data path, and the BTB stores the target address and jump record of the jumps executed by the branch instruction, such that when the same branch instruction is executed again, the past records can be used to predict whether or not to jump to the target address at the stage of the fetch instruction, and thus the next instruction can fetch the predicted execution instruction, so as to lower the possibility of delaying the pipeline by the branch instruction.

Further, the compiling and scheduling skills (such as a delayed branch) of the compiler are used for predicating the execution environment to overcome the branch delay issue, and such measures are research subjects which are adopted gradually by related industries.

In the hardware design of BTB, the BTB stores the information of the most recently executed jump instructions, and thus both of its hardware and cache are of associative memory architecture. Since the BTB timely sends out a predicted address to fetch an instruction to achieve the next fetch (IF) stage, the program counters (PC) of all branch instructions in the BTB field must be read in a cycle. Compared with the present PC values of fetching instructions, the BTB can fetch the related information of the jump instructions more quickly. Since the design of BTB requires an organization of a more expensive and complicated associative memory with a multi-level complicated prediction structure, the data in the BTB fields must be updated synchronously when the instructions are executed, and the delay caused by writing data to the BTB must be lowered, and thus the level of complexity of the control circuit will become very complicated. In short, the BTB operating with a multi-level prediction structure incurs a high hardware cost and a complicated circuit, and thus creating a bottleneck for the executions in the quick pipeline architecture.

At present, reduced instruction set computing (RISC) embedded processor designers declare that the aforementioned effects can be achieved by using the delayed branch technology of the compiler together with the hardware execution function of the predicated execution. However, the following conditions must be met to achieve such effect by the two aforesaid technologies.

(1) All instructions of an instruction set architecture must have a full predication for the conditional execution capability of the predicated execution and completes the conditional executions in different situations. In view of the characteristics of the present microprocessor architecture such as the Intel X86 instruction set architecture and the renowned MIPS and Sprac processor architectures, these architectures do not come with a fully predicated execution design. Although the mainstream of embedded processors or high-end reduced instruction set computer and the Advanced RISC machine (ARM) processor instruction set architecture include all instructions with the fully predicated execution capability, yet the conditional control only adopts simple flags for the control. Once if a condition becomes more complicated, the condition cannot be represented by a single compared N, C, V, or Z flag, and thus the predicated execution exists in name only and cannot operate together with the delayed branch technology to achieve the effect of eliminating the branch hazard.

(2) It is a prerequisite for the delayed branch to employ the instruction set architecture of the related technology, primarily dividing the branch instructions into two types: a delayed branch instruction that will not clear the execution of instructions following a branch in the pipeline and a general branch instruction that will interlock the pipeline and clear the instructions following a branch in the pipeline, or else it is necessary to limit all branch executions from automatically clearing the execution of instructions following a branch in the pipeline, and fills in a NOP instruction if the compiler cannot find an appropriate instruction to fill in the delayed slot, so as to prevent execution errors.

However, the foregoing first method complicates the instruction set architecture, and results in an increase of burden to the hardware, and the foregoing second method is impractical and unsuitable for a superscalar environment having the Out-Of-Order execution capability, and thus the code size will become very large as a large number of NOP instructions are added. Therefore, the RISC embedded processors employ the delayed branch technology of a compiler to integrate with the hardware execution function of the predicated execution, such that the hardware environment confronts stricter and more complicated design requirements.

In view of the pipeline technology, the branch instruction will cause a control hazard to the pipeline, and the pipeline delays fetching the correct instruction. For example, a five-stage pipeline of an ARM-9 architecture has a ranch instruction, and the branch instruction has to go through three pipeline stages including fetch (IF), decode (ID) and execution (EXE) before obtaining the correct branch target address, and thus the fetch of the next instruction must be delayed by two cycles for fetching the correct instruction. As a result, the characteristic of the original stacked execution is ruined and a loss of pipeline performance is created. Since the occurrence of a jump for a branch instruction is completely controlled by the determined result of dynamic conditions, therefore we are unable to predict the execution result. If a jump occurs in a branch instruction, the sequentially fetched instruction will be a wrong instruction. Predicting whether or not a jump occurs for a branch instruction can determine whether the pipeline fetches instruction sequentially or fetches the instruction at a jumped address when the pipeline fetches an instruction. If the prediction is correct, then the branched instruction can be fetched duly to eliminate the foregoing delay.

If it is not necessary to take the cost and design of hardware into consideration for the implementation of the branch prediction, then the BTB is definitely an effective positive solution for the control hazard, and thus BTB is used extensively for high performance processors. However, if the level of hardware complexity is taken into consideration and all branch instructions are processed with the same priority, then directly adopting the BTB technology to emphasize on the features giving a simple structure, supporting specific applications, and providing a low-cost power-saving embedded processor is not an appropriate method.

Since different types of branch instructions have different program structures and characteristics, different policies should be developed for different types of branch instructions to find the most appropriate prediction mechanism to fit that particular type of branch instruction. For the classification of branch instructions, general branch instructions are divided into forward branch instructions and backward branch instructions according to the jump direction. As to the program processing, a forward branch instruction often comes with the “if-then-else” program structure, and whether or not a jump is conducted for a branch instruction depends on the “if” conditions, and the backward branch often comes with the “loop” program structure, and such branch or jump is repeated for hundreds of times until the loop ends. In the processing of forward branch instructions, most forward branch instructions generally occur at the flow control of basic blocks and thus become an increasingly popular predicated execution method that converts the if-then-else control dependence into a data dependence of predicated bits and uses a plurality of function units (FU) for parallel executions to effectively a vast majority of the instructions of this sort. As to the backward branch prediction, the execution frequency is high and the processing is stable and easily predictable, a specific prediction mechanism can be developed to effectively overcome the control hazard produced by the branches of this sort.

### SUMMARY OF THE INVENTION

The primary objective of the present invention is to overcome the foregoing problem by providing a programmable backward jump instruction prediction mechanism that focuses on the microprocessor hardware architecture and aims at the maximization of the execution frequency, and the processing mode provides a unique way of solving the backward branches. Since backward branches have specific behaviors and usually appear in a “nested loop” program structure, therefore a simple effective branch prediction mechanism can be designed specifically according to such behaviors and structural characteristics to overcome the control hazard caused by in the pipeline execution of the instructions of this sort. This mechanism is a backward branch prediction queues (BBQ) design, and thus the level of hardware complexity of the BBQ circuit is very low. With a general pipeline execution, a good prediction effect can be achieved at the first fetch stage.

Another objective of the present invention is to provide a BBQ structure that needs not to store too many instructions or adopt an associative memory technology for rapidly comparing a large number of data, and thus giving an embedded processor with a simple hardware structure and a reasonably low price.

A further objective of the present invention is to adopt a BBQ that can be used with other branch control hazard technology, such as a predicated execution technology, so that the BBQ can perform a backward branch prediction. Further, the predicated execution method is used to remove a vast majority of forward branch instructions or cooperate with a branch target buffer (BTB), such that the BBQ performs a backward branch prediction, and the BTB specially stores and predicts a forward branch instruction, and it is discovered from the verification of present simulated performance that a predicted efficiency twice as much as that for the BTB can be accomplished.

To achieve the foregoing objectives, the mechanism of the present invention includes a backward branch prediction queues (BBQ).

When a program starts executing, the BBQ will encounter an innermost backward branch for the first time in an innermost loop, and the BBQ will find it a branch instruction and determine the innermost backward branch as a backward branch according to the target address of the innermost backward branch and the size of program counter (PC). Therefore, the PC value and target address of the innermost backward branch are stored in the BBQ, and the BBQ encounters the innermost backward branch for the first time and cannot immediately provide the target address. If the same innermost loop is executed at a later time, the BBQ will read the front pointer to find the correct predicted address each time.

If the program exits the innermost loop and enters into a middle loop and the BBQ has a wrong prediction for the innermost backward branch, the BBQ will not clear its content, such that when the execution of the program encounters a middle backward branch, the middle backward branch is also a backward branch, and its target address is in front of the target address of the innermost backward branch, and the PC value of the middle backward branch is greater than the PC value of the innermost backward branch, and the target address of a middle backward branch is less than or equal to the target address of an innermost backward branch, and the PC value of a middle backward branch is greater than the PC value of an innermost backward branch. Therefore, the BBQ will save the middle backward branch into the BBQ. Thereafter, the middle backward branch will jump back for iterations, and the BBQ read the front pointer for resetting to zero. The pointer value is zero and points at the innermost backward instruction jump information stored in the BBQ, so that the innermost loop stored in the BBQ quickly provides the target address of the innermost backward branch until the jump prediction fails for the last time. By then, the front pointer will enter into the next prediction and adjust the prediction as the next prediction for the middle backward branch, wherein the previous BBQ only records the innermost loop. With this limitation, the middle loop cannot be guessed. If the middle loop is executed, the BBQ will record the middle loop, so that when a wrong guess for the innermost loop occurs again, we know that the next loop should be the middle loop. If the middle backward branch predicts the middle loop successfully, the front pointer of the BBQ will be returned automatically to the starting point, so that the next prediction will be an execution of the innermost backward branch. Thereafter, the BBQ will repeat operating the aforementioned process and keep running the innermost loop and the middle loop alternately. By then, the field of the BBQ records the “Dual loop state”, and this state will be maintained continuously until the execution of the middle loop no longer has a backward jump (and the middle backward branch backward jump is an error) and the execution is ready to enter into an outermost loop.

If the program executes the outermost loop, the program will encounter an outermost backward branch. Since the BBQ encounters the outermost backward branch for the first time, no record exists in the BBQ, and the prediction mechanism will fail for sure. Similarly, the outermost loop is comprised of a nested loop of the outermost backward branch, and thus the target address (of the outermost backward branch) is less than or equal to the target address (of the middle backward branch) and the PC value (of the outermost backward branch) is greater than the PC value (of the middle backward branch). The BBQ will not be cleared, but will add the record of the outermost loop directly. By then, the BBQ will set a prediction mechanism to predict a backward branch for the next time, so as to return to the innermost loop, and then the field of BBQ will store “Three-level loop state” and will switch among the innermost loop, middle loop and outermost loop alternately and continue the execution until no jump occurs. Now, the BBQ prediction ends and gets ready to exit the nested loop, but the content in the field BBQ is not cleared yet, and another new outer nested loop may be added, such that if the execution encounters another outer backward branch and the comparison by the BBQ finds the conditions unmatched, the target address (of another outer backward branch) is greater than the target address (of the outermost backward branch) and the PC value (of another outer backward branch) is less than the PC value (of the outermost backward branch ), and then the BBQ will be cleared, and the other outer backward branch will be stored into the BBQ, just like the situation of returning to the BBQ and the PC value of the innermost backward branch and the target address are stored in the BBQ.

Further, the prediction mechanism of the invention is designed in a hardware circuit, and the circuit is a backward branch prediction queues (BBQ) circuit comprising a backward branch prediction queues (BBQ) prediction mechanism and a multi-stage pipeline of an advanced RISC machine (ARM) processor as a basic architecture and operates with the BBQ prediction mechanism to install a fetch pipeline circuit, a decode pipeline circuit and an execution pipeline circuit at the three pipeline stages: Fetch (IF), Decode (ID) and Execution (IE) respectively, and a bus with a 32-bit signal line is used in the BBQ circuit for transmitting data or control signals.

If an instruction enters into a fetch stage, the fetch pipeline circuit uses a NPC multiplexer to select an address and writes the address into a next program counter (NPC) as the address for a fetch instruction of the next fetch stage, the NPC multiplexer will accept the cumulative value of an arithmetic logic unit (ALU), a memory access, and a program counter (PC) and the data line input of the target address of a front prediction backward branch, such that the BBQ circuit can provide a next fetch stage when the prediction is executed, so as to generate and predict the address of the instruction. The fetch pipeline circuit further comprises a compare circuit for determining whether or not the current PC value of the fetch instruction is equal to the PC value of the BBQ circuit prediction instruction and using a 1-bit line to determine whether or not to sent the comparison result of a control line output of the target address of the BBQ prediction to the NPC multiplexer. If the two PC values are equal, then the NPC multiplexer will be controlled to send out the target address of a read prediction backward branch and write the target address into the next program counter (NPC).

After the instruction enters into a decode stage, the decode pipeline circuit will use the [27:23] bits of the fetch instruction to determine whether or not the instruction is a branch instruction, and distinguish the type of branch instruction such as a forward jump instruction or a backward jump instruction, and uses a 1-bit control signal line for determining the backward jump branch instruction and a 1-bit control signal line for determining the forward jump branch instruction to output signals for the use of the BBQ circuit of the execution pipeline stage. The condition field of [31:28] bits and the NZCV flag are used for determining whether or not the condition of the instruction is established and the result of the determination is outputted to the next stage and the BBQ circuit of the execution pipeline stage by using a 1-bit signal line that determines the jump of a branch instruction.

The decode pipeline circuit further comprises a quick addition circuit for obtaining a target address of the branch instruction at a pipeline stage in advance, so as to determine the backward branch jump record stored by the BBQ circuit at the decode stage in advance and determine whether or not the new backward branch constitutes a nested loop or causes an error that ruins the BBQ prediction mechanism. The decode pipeline circuit uses a comparator to determine the target address of the outmost nested loop stored in the BBQ, and the PC value of the outermost nested loop stored in the BBQ is compared with the target address and PC value of the new branch instruction, and the result determined by the comparator will be outputted to the BBQ circuit at the next stage by using a 1-bit signal line that determines a nested loop signal line.

After the instruction enters into an execution stage, the execution pipeline circuit will select and read the prediction instruction according to the BBQ prediction mechanism and update the BBQ field.

To make it easier for our examiner to understand the objective of the invention, its structure, innovative features, and performance, we use a preferred embodiment together with the attached drawings for the detailed description of the invention as follows.

### BRIEF DESCRIPTION OF THE DRAWINGS

FIG. 1A is a structural diagram of a simplified three-level nested loop of the present invention;

FIG. 1B is a flow chart of a program executed by a simplified three-level nested loop program structure of the present invention;

FIG. 2 is a flow chart of a BBQ operation according to a first preferred embodiment of the present invention;

FIG. 3A is a schematic diagram of a first situation of a forward branch affecting the regular behavior of nested loops according to the present invention;

FIG. 3B is a schematic diagram of a second situation of a forward branch affecting the regular behavior of nested loops according to the present invention;

FIG. 3C is a schematic diagram of a situation of a forward branch affecting the regular behavior of nested loops and ruining the accurate prediction of BBQ according to a second preferred embodiment of the present invention;

FIG. 4A is a structural diagram of a subroutine having a nested loop backward branch program according to the present invention;

FIG. 4B is a flow chart of a program execution of a subroutine having a nested loop backward branch program according to the present invention;

FIG. 5 is a schematic diagram of a subroutine call with a depth of stacked BBQ equal to 2 according to a third preferred embodiment of the present invention;

FIG. 6 is a schematic view of the action of a stacked BBQ according to a third preferred embodiment of the present invention;

FIG. 7 is a schematic diagram of a stack BBQ when calling a plurality of subroutines according to the fourth preferred embodiment of the present invention;

FIG. 8A is a schematic diagram of the logic of a recursive subroutine occurred in a stacked BBQ prediction according to the present invention;

FIG. 8B is a schematic diagram of a stack record of a recursive subroutine occurred in a stacked BBQ prediction according to the present invention;

FIG. 9 is a flow chart of a BBQ merged into an instruction pipeline operating flow of a processor according to the present invention;

FIG. 10 is a block diagram of a BBQ circuit according to a fifth preferred embodiment of the present invention;

FIG. 11 is a diagram of an overall circuit architecture of a BBQ circuit at the stages of fetching, reading and executing a pipeline according to a fifth preferred embodiment of the present invention;

FIG. 12 is a schematic diagram of the stages of executing a pipeline in a BBQ circuit which is divided into three circuits: a BBQ store circuit, a BBQ control circuit and a BBQ pointer adjust circuit according to a fifth preferred embodiment of the present invention;

FIG. 13 is a flow chart of the pipeline of a stacked BBQ merged into the instruction of a processor according to the present invention;

FIG. 14A is a circuit block diagram of each BBQ in a stacked BBQ according to a sixth preferred embodiment of the present invention;

FIG. 14B is a circuit block diagram of a shared dynamic pointer of each BBQ circuit in a stacked BBQ according to a sixth preferred embodiment of the present invention;

FIG. 15A is a structural diagram of the whole stacked BBQ circuit according to a sixth preferred embodiment of the present invention;

FIG. 15B is a block diagram of a stacked BBQ controller circuit of a sixth preferred embodiment of the present invention;

FIG. 16 is a schematic view of a stacked BBQ controller circuit of a sixth preferred embodiment of the present invention;

FIG. 17 is a schematic view of a stack entry of a stack circuit in a stacked BBQ controller according to a sixth preferred embodiment of the present invention;

FIG. 18 is a circuit block diagram of a PUSH circuit of a control circuit in a stacked BBQ controller according to a sixth preferred embodiment of the present invention;

FIG. 19 is a circuit block diagram of a POP circuit of a control circuit in a stacked BBQ controller according to a sixth preferred embodiment of the present invention;

FIG. 20 is a distribution chart of different types of instructions when verifying the execution of a program of a BBQ prediction mechanism according to the present invention;

FIG. 21 is an analysis chart of the hit rate of a prediction of a backward branch for simulating the BBQ prediction mechanism by a sim-bpred module;

FIG. 22 is a comparison chart of the hit rates of two different branch prediction performances of BTB and BBQ; and

FIG. 23 is an analysis chart of the enhanced performance after simulating, evaluating and adding the BBQ prediction mechanism.

FIG. 24 shows a table of input/output data and control signals of the BBQ circuit according to a fifth preferred embodiment of the present invention;

FIG. 25 shows a table of input/output signals of the BBQ control circuit according to a fifth preferred embodiment of the present invention;

FIG. 26 shows a truth table of the BBQ pointer adjust circuit according to a fifth preferred embodiment of the present invention;

FIG. 27 shows a table of input/output signals of the stacked BBQ circuit according to a sixth preferred embodiment of the present invention;

FIG. 28 shows a table of input/output signals of the PUSH circuit of a control circuit in the stacked BBQ controller and a truth table according to a sixth preferred embodiment of the present invention;

FIG. 29 shows a table of input/output signals of the POP circuit of a control circuit in the stacked BBQ controller and a truth table according to a sixth preferred embodiment of the present invention; and

FIG. 30 shows a table listing the Simplescalar simulated parameter settings.

### DETAILED DESCRIPTION OF THE PREFERRED EMBODIMENTS

The structure, technical measures and effects of the present invention will now be described in more detail hereinafter with reference to the accompanying drawings that show various embodiments of the invention.

The prediction of a backward branch for a backward branch prediction queues (BBQ) performed by a prediction mechanism of the present invention comes from the characteristic of repeated execution of a loop. Firstly, the execution will be usually repeated for many times if the program encounters a loop. Secondly, the jump position of each loop has the same address. Thirdly, if successive backward branches form a nested loop structure, then the execution sequence of the backward branches also has a specific mode, and the present invention follows this characteristic to establish an effective branch prediction strategy. Due to the first characteristic, the loops occupy a very large percentage of the program execution, and a successful strategy must bring in a certain level of improvements on the performance, the prediction mechanism for a backward branch can follow the characteristics of a loop to improve the accuracy of the prediction instead of blindly comparing the addresses of the program counters (PC) of all branch instructions, and thus a large memory used for supporting the addresses of instructions and the hardware circuit for the comparison will be so large, and the invention can lower the hardware cost greatly.

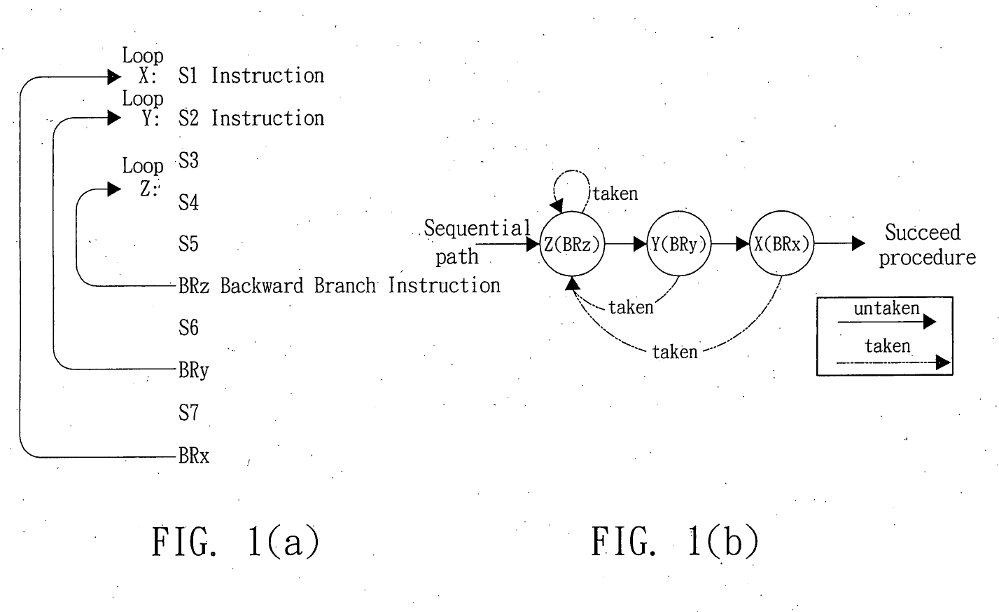

An example for analyzing the behaviors of a nested loop is given. FIG. 1A is a structural diagram of a simplified three-level nested loop of the present invention and FIG. 1B is a flow chart of a program executed by a simplified three-level nested loop program structure of the present invention. In FIG. 1A, X:, Y: and Z: represent the target addresses of the backward branches; BRz, BRy and BRx represent the backward branches; and S1 to S7 represent instructions other than the branch instructions. In FIG. 1B, Circles Z, Y and X represent loops at different levels, and the dotted lines represent jumps of backward branches, and the solid lines represent a sequential flow without a jump of a backward branch.

From the behavior of the nested loop, it is observed that the execution sequence of each backward branch is similar to a queue that repeats its execution from {Z} to {Z,Y} and further to {Z,Y;X}, but its behavior is actually quite different from a queue. The whole nested loop is processed about a starting point. Once if there is a jump for a backward branch of a nested loop, the nested loop will return to the starting point (which is indicated by z in FIG. I B), and if there is no jump, then the nested loop will enter into the next loop. From this mode of jump, we need to know the address of such jump which is the predicted address, and such address is not just fixed but there is a regular pattern of their sizes (either in the front or at the back). In other words, the whole BBQ is developed according to the concept of the characteristics of the nested loop, and we can predict the situation of the whole nested loop jump and improve the hit rate of the prediction.

Based on the foregoing analysis of behaviors, we discovered that it requires a read pointer (which is a front pointer) to store a record of the BBQ prediction and sequentially read the stored data. Only one record of data in a field is read at a time to provide the record required for the prediction and write in a pointer (which is a rear pointer) and sequentially write the record of the required jump, and each write will shift to the next field for writing in a new data.

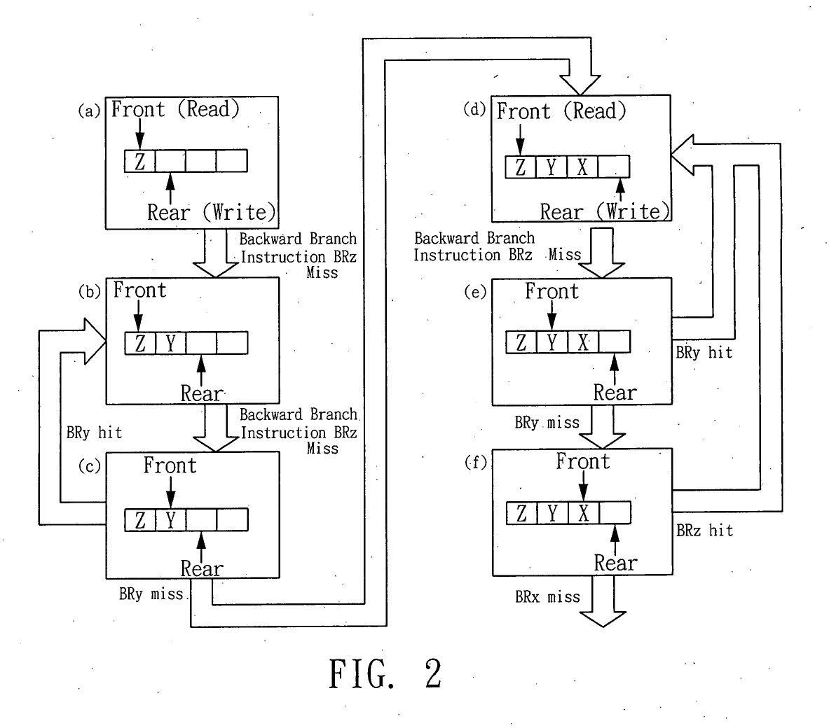

Refer to FIG. 2 for the illustration of the way of BBQ controlling and accurately storing the nested loop according to a preferred embodiment of a programmable backward jump instruction prediction mechanism of the present invention.

When a program starts its execution and an innermost backward branch BRz is encountered for the first time in an innermost loop Z, the BBQ discovers that it is a branch instruction, and the target address and the magnitude of the PC value are used to determine a backward branch, and thus the PC value of the innermost backward branch BRz and the target address are stored in a BBQ first as shown in FIG. 2A. Although the BBQ encounters the innermost backward branch BRz for the first time and cannot immediately provide a target address, but thereafter if the same innermost loop Z is executed, the BBQ will read the front pointer by the BBQ to locate the correct predicted address for each time.

If the execution of the program exits such innermost loop and enters into a middle loop Y and the BBQ has a wrong prediction on the innermost backward branch BRz, the BBQ will not clear its content. Until the program execution encounters a middle backward branch BRy, the middle backward branch BRy is also a backward branch, and its target address is in front of the target address of the innermost backward branch BRz, and the PC value of the middle backward branch BRy is greater than the PC value of the innermost backward branch BRz, and the target address (of the middle backward branch BRy) is less than or equal to the target address (of the innermost backward branch BRz) and the PC value (of the middle backward branch BRy) is less than the PC value (of the innermost backward branch BRz), and thus the BBQ will store the middle backward branch BRy in the BBQ as shown in FIG. 2B. Thereafter, the middle backward branch BRy will jump back to repeat the execution, and the read front point of the BBQ is reset to zero, and the value of the pointer is exactly equal to zero (pointing at the jump information of a backward instruction of the innermost loop stored in the BBQ) to quickly provide the address of the innermost backward branch BRz from the innermost loop Z, until the last jump prediction fails. By then, the read front pointer will enter into the next prediction, and adjust the prediction to the next prediction for the middle backward branch BRy as shown in FIG. 2C (The previous BBQ only records the innermost loop Z, and with such limitation, it is unable to guess the middle loop Y, but when the middle loop Y is executed, the BBQ will record the middle loop Y, such that when the innermost loop Z is guessed wrong again, we know that the next loop is the middle loop Y). After the middle backward branch BRy instruction successfully predicts the middle loop Y, the read front pointer of the BBQ will return to the starting point automatically as shown in FIG. 2C, so that the next prediction will be an execution of the innermost backward branch BRz. Thereafter, the BBQ will repeat the foregoing operation and continue changing the process between the innermost loop Z and the middle loop Y alternately. By then, the BBQ field will record a “Double level loop status” and such status will remain until the execution of the middle loop Y no longer has a backward jump (and there is a miss of the backward jump for the middle backward branch BRy) and the prediction ends and gets ready to enter into the next loop and the outermost loop X.

Then, the program continues executing the outermost loop X and encounters an outermost backward branch BRx. Since it is the first time to encounter the outermost backward branch BRx, the BBQ will not have any record, and the prediction mechanism must fail. Similarly, this loop X is a backward branch and constitutes a nested loop (the target address (BRx) is less than or equal to the target address (BRy) and the PC value (BRx) is greater than the PC value (BRy)). Therefore, the BBQ will not be cleared, but it will be added directly into the record of the outermost loop X as shown in FIG. 2D. Then, the BBQ prediction mechanism is set to predict the next encountered backward branch and jump back to the innermost loop Z, and the BBQ field will store a “three-level loop status” and make changes as shown FIGS. 2D, 2E and 2F. In FIG. 2F, the execution continues until the outermost loop X no longer has a jump, and then the prediction ends and gets ready to exit this nested loop, but the content in the BBQ field will not be cleared yet and it is ready to add a new outer nested loop W. If the execution encounters another backward instruction (BRw) later, the BBQ compares and finds an unmatched condition (the target address of another outer backward branch BRw is greater than the target address of the outermost backward branch BRx, and the PC value of another outer backward branch BRw is less than the PC value of the outermost backward branch BRx), then the BBQ will be cleared, and another outer backward branch BRw will be stored in the BBQ, similar to the situation of returning as shown in FIG. 2A.

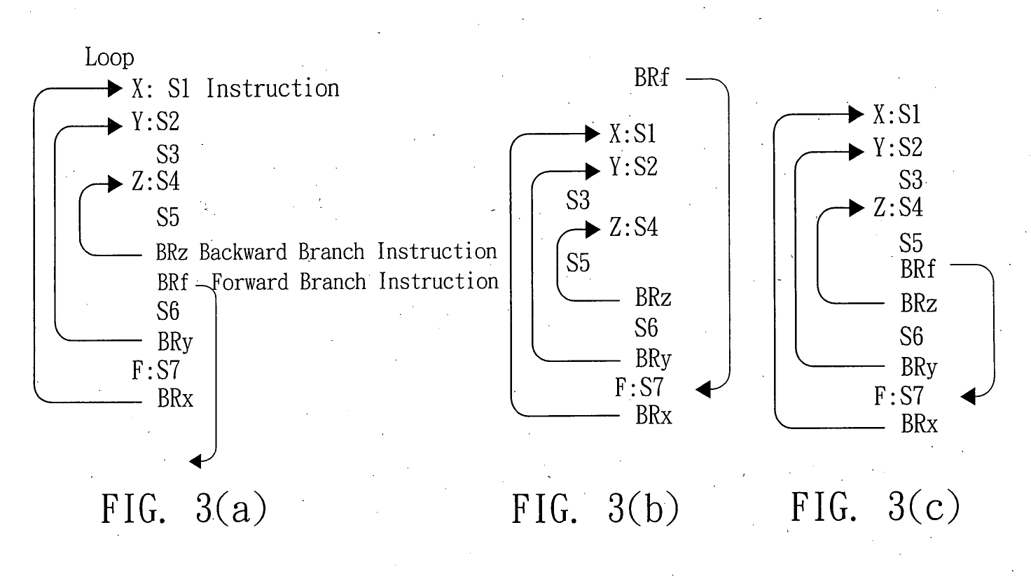

The way of the forward branch behavior ruining the prediction accuracy of the BBQ will be described in detail as follows. Although the BBQ does not store the information of a forward branch, the flow running from the interior to the exterior of a nested loop will be ruined after the forward branch instruction jumps. Therefore, the prediction mechanism has to take the effect of the forward branch instruction on the BBQ prediction mechanism into consideration for the dynamic/static analysis of the application program. The forward branches of this sort that will after the regular behaviors of the nested loop are divided into three types as shown in FIG. 3.

The situations as shown in FIGS. 3A and 3B will not ruin the existing prediction mechanism of the BBQ and at most it may confuse the BBQ to store unnecessary information only. As the loop continues, the BBQ will determine to rearrange the predicted information of the foregoing mechanism, so as to eliminate the interference of the jumps of this sort.

The situation as shown in FIG. 3C is more complicated. If a forward branch instruction BRf occurs in a nested loop, and its target address is situated in the loop, and the PC value of the forward branch instruction BRf (which refers to the address of the forward branch instruction BRf) and its target address (which refers to the address of the next execution instruction after the forward branch instruction BRf jumps) exceed the innermost backward branch BRz of the nested loop, and thus after the forward branch instruction BRf is executed, the address will be shifted to the target address of the forward branch instruction BRf and will jump over the address of the innermost backward branch BRz (the innermost backward branch BRz has not been executed). Refer to FIG. 3C for the illustration of a second preferred embodiment of the present invention. The target address of the jump of the forward branch instruction BRf exceeds the backward branch BRy, and thus affecting the execution and causing damages. If the forward branch instruction BRf jumps, it will exit the process of the innermost loop Z, Since the forward branch instruction BRf jumps and the flow enters directly into an outermost loop X without going through the middle loop Y, such that after the execution exits the innermost loop Z, the predicted backward branch of the BBQ is a middle backward branch BRy, because the effect of the middle backward branch BRy on the forward branch instruction BRf cannot be predicted accurately and a prediction error will result and ruin the BBQ prediction mechanism, and the forward branch instruction BRf in the nested loop will be repeated continuously according to the loop, and thus the damage caused by the repeated executions will be much larger. Based on the analysis of a dynamic execution of the application program, we discovered that the situation of this sort occupies about 0.9139% of the total number of executed instructions. Particularly in certain specific applications such as the testing program jpeg and dijkstra shortest path occupy 5.773% and 16.839% of the total number of the branch instructions respectively, and thus it will affect the prediction performance of the BBQ in application programs of this sort.

To overcome the influence of these forward branch instructions to the BBQ, a comparator is used for comparing and determining whether or not the target address of the jump of the forward branch instruction BRf is greater than the address of the predicted PC value of the current BBQ according to the target address of the jump of a forward branch instruction and the jump information recorded in the current BBQ field. If the target address is greater, then the BBQ will locate the address of the predicted PC value of the next valid field, and the comparator will determine the result until the result is no longer greater than the target address, and will dynamically adjust the front pointer to point at the located valid BBQ field and send out the correct predicted address; or else, the BBQ will remain unchanged.

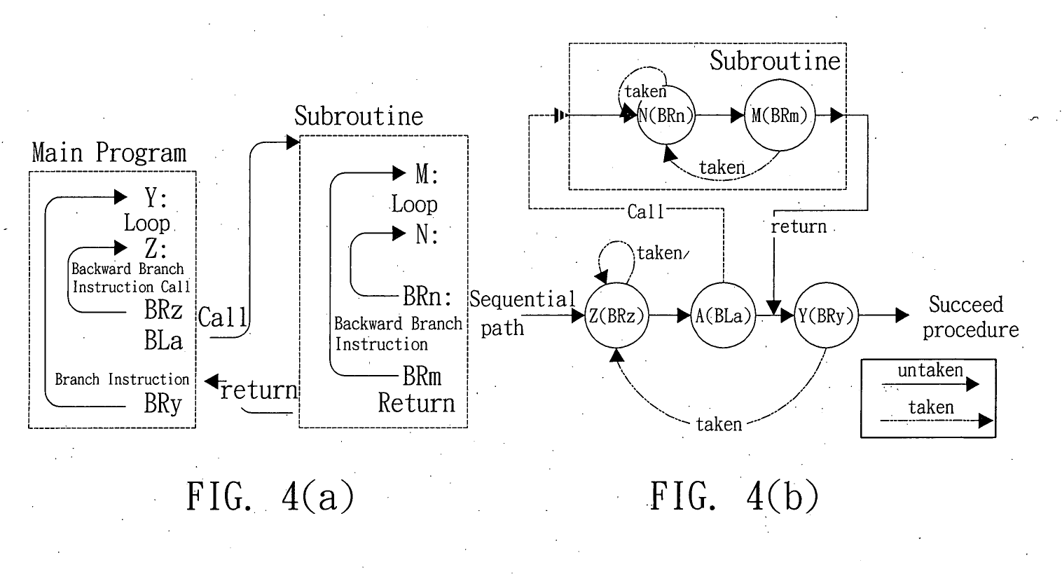

The behaviors of the subroutine that ruins the accuracy of predicting the BBW will be described in detail as follows. The instruction calling the subroutine is also a branch instruction, and the current BBQ data will lose its value temporarily upon a program call, and the value will be recovered soon, and thus it is worthy to further consider such behavior for the design of recovering the BBQ data to provide a better design. If the subroutine contains a backward branch as shown in FIG. 4A and two backward branches BRm, BRn executed in a subroutine call that calls a branch instruction Bla, the program behavior of a nested loop comprised of the originally stored main program loop Z and main program loop Y will be ruined. After the subroutine is called, the originally stored loops Z and Y of the loop prediction mechanism will be cleared, and the branch instruction Bla of the called subroutine is situated beyond the loop Z and within the loop Y. If the loop Z records the address and exits the loop Z after the prediction, the subroutine will be called, and loop Z will not be affected, and the loop Y will constitute a nested loop containing a branch instruction BLa for calling the subroutine, and the backward branches BRm, BRn in the subroutine will clear the record of the jump of the loop Y whenever the subroutine is called and after the loop Y creates a jump record each time. Further, the nested loop in the subroutine will be predicted, and thus the loop Y cannot predict successfully, and the nest loop originally comprised of the loop Z and the loop Y cannot be predicted thoroughly. Although the nested loop in the subroutine is affected by the record of BBQ before the subroutine is called and a miss is produced at the beginning, the accuracy of predictions that follow will not be affected.

Referring to FIG. 4B for the flow chart of the process, we discovered that both main program loop Z and main program loop Y as well as both subroutine loop M and subroutine loop N are independent nested loops. If two separate BBQ prediction mechanisms are provided for the main program and the subroutine and the branch instruction Bla for calling a subroutine is used for the control of the switching, then the prediction miss of the BBQ caused by the foregoing interference can be avoided effectively.

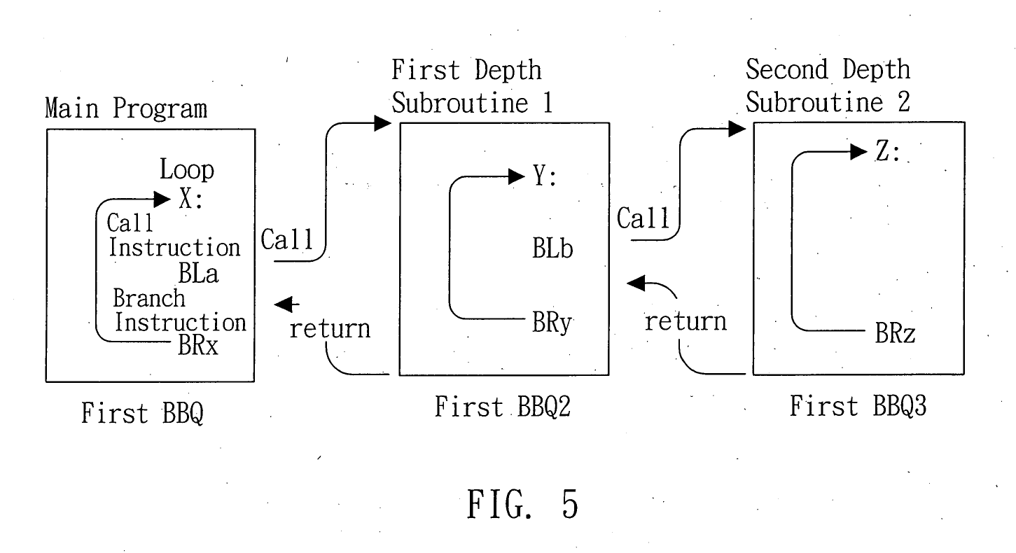

Since the BBQ prediction mechanism of the present invention comes with a simple circuit hardware and a low price, several separate sets of main program and subroutine provided for the use of separate BBQs to avoid the foreign interference to the BBQ caused by the branch instruction that calls a subroutine will not increase the level of complexity of the hardware too much. The continuous call/return of a subroutine with a first call last return (FCLR) characteristic matches with the characteristic of a first in last out (FILO) of a stack, and thus a stack circuit is added for continuously storing the information of the called/returned subroutines and controlling and switching several sets of BBQs. We call such arrangement as a stacked backward branch prediction queue (Stacked BBQ), and a subroutine having a depth equal to two is used for illustrating a third preferred embodiment of the present invention as shown in FIG. 5.

The program includes a main program and a subroutine having a depth equal to two (a first depth subroutine 1 and a second depth subroutine 2 situated at the next depth of the first depth subroutine 1). Further, the main program includes a main program loop X, and the main program loop X includes a main program backward branch BRx, and a branch instruction Bla for calling the first depth subroutine 1 is located in the main program loop X. The first depth subroutine 1 has a first depth subroutine loop Y, and the first depth subroutine 1 includes a first depth subroutine backward branch BRy, and a second depth subroutine branch instruction BLb for calling the second depth subroutine 2 is situated in the main program loop Y

The prediction mechanism includes a plurality of BBQs to form a stacked backward branch prediction queue (stacked BBQ) for using the first BBQ1 separately by the main program, and the first depth subroutine 1 separately uses the second BBQ2, and the second depth subroutine 2 separately uses the third BBQ3; and a stack circuit is provided for storing the information of each depth subroutine of the continuous call/return and control the switching between the BBQs.

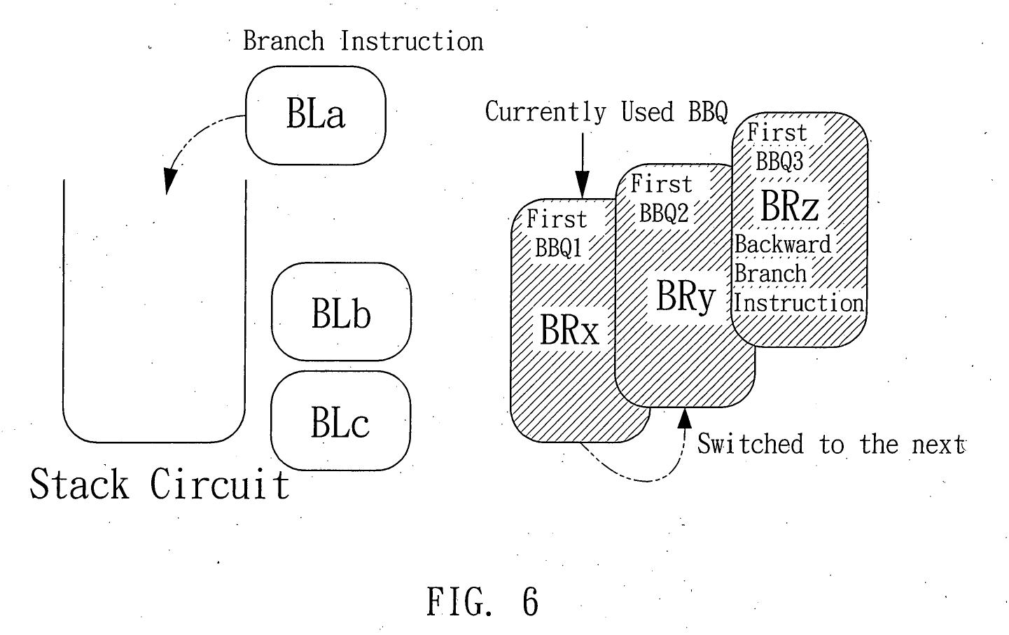

If a first depth subroutine branch instruction Bla calls a first depth subroutine 1 in a program execution, the stacked BBQ will push the record of this branch instruction into the stack circuit, and control to switch the currently used first BBQ1 to the next and second BBQ2 (as shown in FIG. 6), and the originally used first BBQ1 maintains the original field unchanged. If the first depth subroutine 1 has not been returned, the second depth subroutine branch instruction BLb will continue calling the second depth subroutine 2, the called second depth subroutine branch instruction BLb will be pushed into the stack circuit similarly to switch the second BBQ2 to the next and third BBQ3. If the second depth subroutine 2 that calls a second depth subroutine branch instruction BLb is returned, then the second depth subroutine branch instruction BLb will be called and popped from the stack circuit, and the program execution is switched and returned to the previous second BBQ2.

After the sacked BBQ prediction mechanism is added, each subroutine uses a separate BBQ. If the issue of the depth for calling a subroutine is taken into consideration, we cannot unlimitedly increase the number of BBQs for the use of every subroutine, and thus the stacked BBQs are allocated for the use of BBQ according to a priority that can effectively determine whether or not the subroutine can separately use a BBQ or several subroutines share a BBQ, so as to reduce the required number of BBQs for the depth for calling a subroutine. Furthermore, the special iterative behavior of a subroutine is considered, and its subroutine keeps on calling is still the same subroutine, and thus the priority strategy for allocating the use of BBQ based on such special behavior is needed.

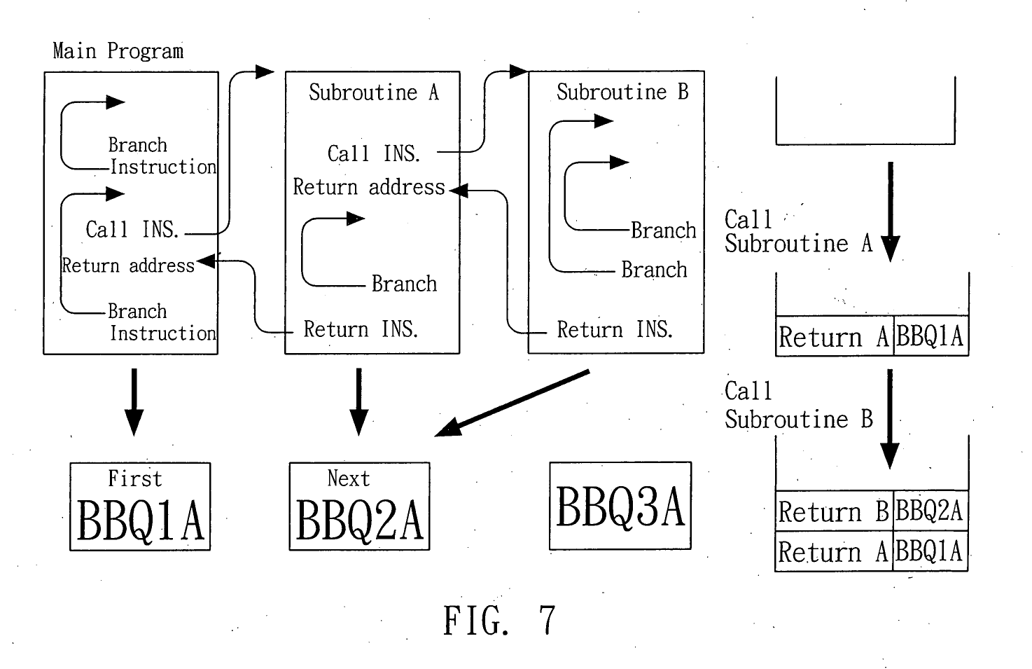

Referring to FIG. 7 for the subroutine having a depth equal to two according to a fourth preferred embodiment of the present invention, the stacked BBQ is allocated for the strategy of the priority of the BBQ, such that the number of BBQs for the subroutine calling depth can be reduced by determining whether or not each subroutine can separately use a BBQ or several subroutines share a BBQ.

In the situation of a program calling a subroutine as shown in FIG. 7, the subroutine has not been called at the beginning yet, and the stacked BBQ prediction mechanism will select to use a first BBQ1A. If the first BBQ1A stores a jump record of a backward branch of a main program and the subroutine A is called, then the jump record will be used again when the subroutine stored in the first BBQ1A returns, and thus the first BBQ1A is switched to the next BBQ2A for the use by the subroutine A. The jump record of calling the subroutine A, the return address and the serial number of the currently used next BBQ2A are pushed into the record of the stack circuit. After the program enters into subroutine A, the subroutine A has not used the jump record of the backward branch stored in the next BBQ2, and thus when the subroutine A calls the subroutine B, the BBQ2A will be in an unused status. By then, the stacked BBQ only pushes the record of calling the subroutine B into the stack circuit but does not switch the BBQ circuit. The same set of BBQ2A circuit is provided for the use by the subroutine B, and thus such arrangement can reduce the number of required BBQ circuits and effectively use the BBQ. If the subroutine B is returned, the jump record of the currently used BBQ will be cleared, and the record at the top of the stack circuit will be popped and the serial number of the BBQ circuit used by the subroutine A according to the record will be used for the corresponding BBQ. If the subroutine B is not called and after the subroutine A is returned, the same operation will be performed to switch the BBQ circuit back to the first BBQ1A.

The advantage of such arrangement resides on that after the stacked BBQ mechanism is added, both main program and subroutine use a separate BBQ, and the interface of the backward branch between subroutines caused by the call/return of the subroutine can be avoided to improve the accuracy of BBQ prediction.

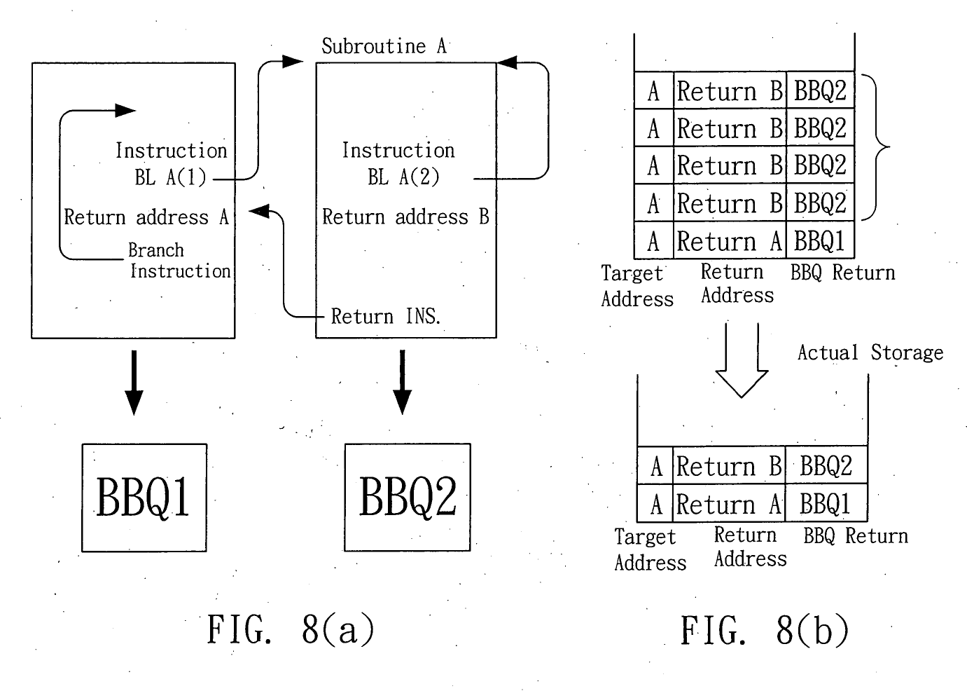

The iterative behavior occurred at the stacked BBQ prediction will be described in detail as follows, and a large percentage of iterations occurred at the calling behavior of a subroutine, and the iteration continuously calling a subroutine causes an increase of depth of the subroutine. If no special consideration is taken, the number of BBQ circuits may be insufficient and the function of the stacked BBQ may be lost. Since the program codes for different iterative programs are the same, and the behavior of the program only requires a fixed BBQ circuit. Referring to FIG. 8 for the behavior of the iterative calls, the way of identifying an iterative call behavior and only using one set of BBQ circuit for a backward branch prediction will be described below.

FIG. 8A shows a simplified iterative program logic, and an instruction BL_A(1) calls a recursive subroutine A for the first time, and then the instruction BL_A(2) will keep calling the subroutine A. Since its target address A is the same as the previous record, therefore when the subroutine is called for the first time, the stacked BBQ will switch to the next BBQ circuit for the use by the subroutine A, but as the subroutine A calls; the BBQ circuit needs not to switch to the next BBQ circuit, but only uses a current fixed BBQ2, and the recursive subroutine is returned to the previous BBQ1 for assuring the processing of the instruction BL_A(1). Since the call/return of the instruction BL_A(2) uses the same set of BBQ circuit, therefore it is not necessary to switch to the BBQ circuit for each return.

In view of the result of pushing the record of each call into the stack as shown in FIG. 8B, the recursive behavior stores the jump record into the stacker continuously, and the jump records of the branch instruction BL_A(1) and the branch instruction BL_A(2) only return different addresses, but the addresses for calling the subroutine address are the same. Therefore, the stacker only stores a record into the stack for the same records. When the address of the same procedure is called continuously, we can determine that it is a recursive call, and there is no need of switching to the next BBQ circuit but simply pushing the jump record into the stack. If the return address of the branch instruction is the same as the address at the top of the stack are the same, it means that the same instruction keeps calling the subroutine. Therefore, it is not necessary to push the record into the stack, and the current record at the top of the stack is a recursive call.

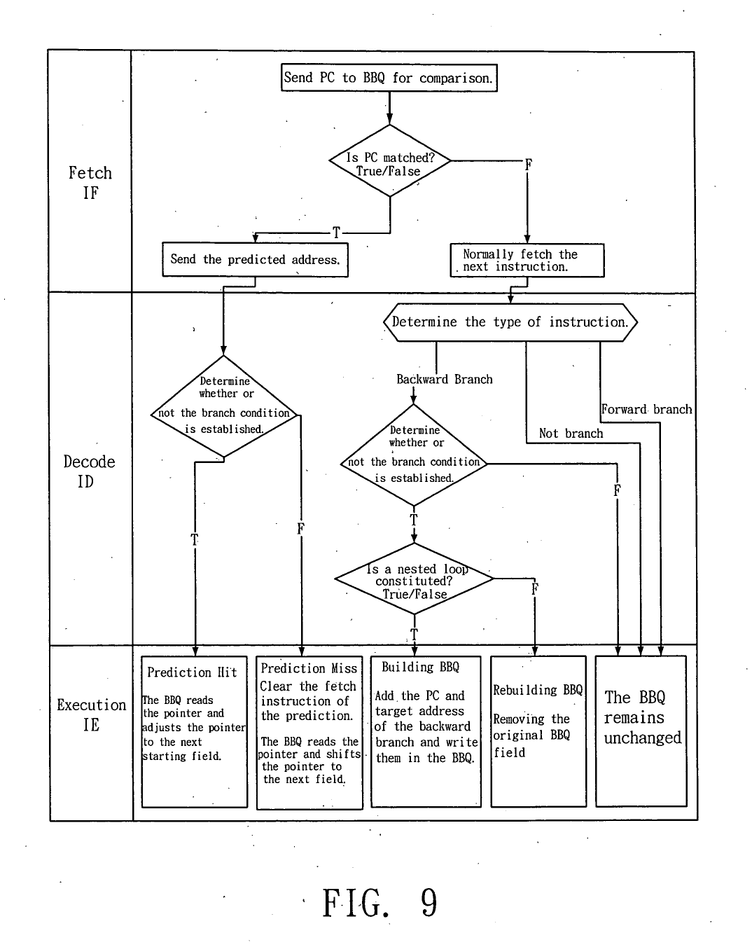

The operating mode of the BBQ is merged into the pipeline processing flow of the instructions of the processor, and a five-level; pipeline of an advanced RISC machine (ARM)-9 processor is used as an example for the illustration, and the BBQ operation is shown in FIG. 9, and the operations produced in the three stages: a fetch (IF), a decode (ID) and an execution (IE) are described as follows.

In a fetch stage (IF stage), a PC value is sent to the address of the desired fetch instruction in the BBQ, and the BBQ reads the record corresponding to the front pointer and compares the record to determine whether or not the BBQ is recorded as the current predicted backward branch. If the compared results match, the target address of the predicted branch instruction is sent out as the address for a fetch instruction. If the compared results do not match, then the BBQ remains unchanged and the pipeline is executed as usual.

In a decode stage (ID stage), the description will be divided into two sections. The “left line flow” indicates that the instruction is an executed backward jump instruction and has produced the predicted branch effect in the previous stage. If the conditions for its conditional branch instruction are established, then the BBQ prediction will be accurate. On the other hand, if the conditions are not established, then it indicates a miss of the BBQ prediction. Now, it is necessary to clear the fetch instruction predicted by the BBQ and record the accuracy of the instruction address of the fetch in the pipeline. The “right line flow” indicates that the instruction is not recorded in the current predicted backward branch of the BBQ. If the execution of an instruction is determined as a branch instruction by a decoder and the instruction is a backward branch and a jump occurs, then the target address of the jump and the jump record stored in the BBQ are used to determine a nested loop. To determine a nested loop, the target address and PC of a new backward branch and the field stored in the outermost loop of the BBQ are used for the determination. If no nested loop is formed, then the BBQ exits the recorded nested loop, and both will update the record of the BBQ field at the execution (EE stage).

In the execution (IE stage), the description will be divided into two sections. The “left line flow” indicates that the instruction is an executed backward jump instruction, and produces a predicted branch effect at the fetch stage. The first line on the left side “Correct Prediction” indicates that the backward branch previously recorded in the BBQ is executed again, and the jump is predicted, and a jump is actually taken place. By then, a correct BBQ prediction can be achieved. Based on the characteristics of the nested loop, no other branch instruction has changed the program flow, and the next instruction of the flow will return to the innermost nested loop created by the BBQ, and thus the front pointer of the predicted address read by the BBQ is read to point at the starting point (which is the innermost nested loop). The second line on the left “Prediction Miss” indicates that the front pointer of the predicted address read by the BBQ points at the next BBQ field (which is the next loop), since there is no jump occurred for its predicted branch jump. It also indicates that the program flow exits from the present loop to the next loop, and thus the pointer is changed to point at the next loop. The “right line flow” indicated by the two lines on the utmost left side constitutes the BBQ, and it shows that when the instruction goes through the flow at the decode stage (ID stage), the instruction is confirmed as a backward branch having a jump and not recorded in the BBQ prediction and such instruction and the instruction stored in the BBQ field constitute a nested loop to be stored in the BBQ field. On the other hand, if no nested loop is constituted, then the record in each field of the current BBQ will be cleared and then the record of the instruction is stored to create another new nested loop again. The flow of BBQ indicated by the three lines on the utmost right side remains unchanged, and it indicates that such instruction is a backward branch but no jump has occurred yet, or there is no backward branch at the first place. Therefore, the BBQ will not take any particular action in this case.

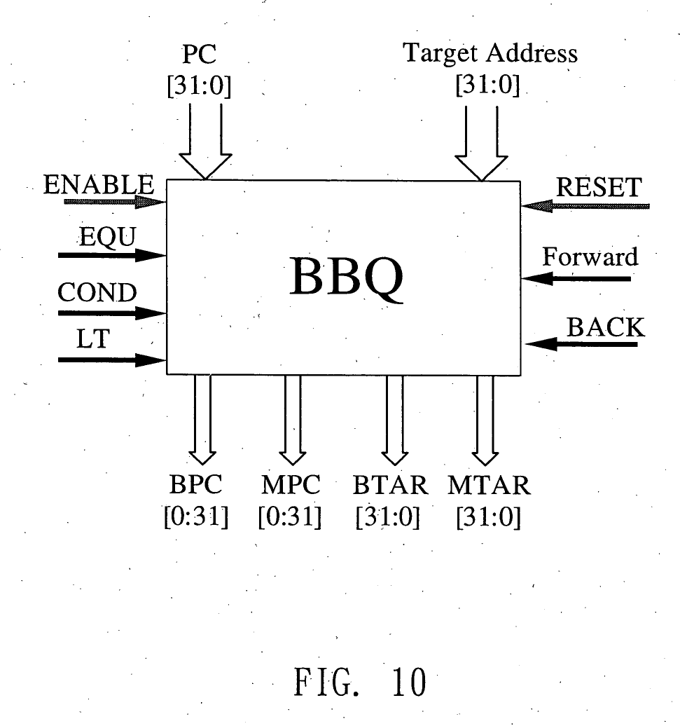

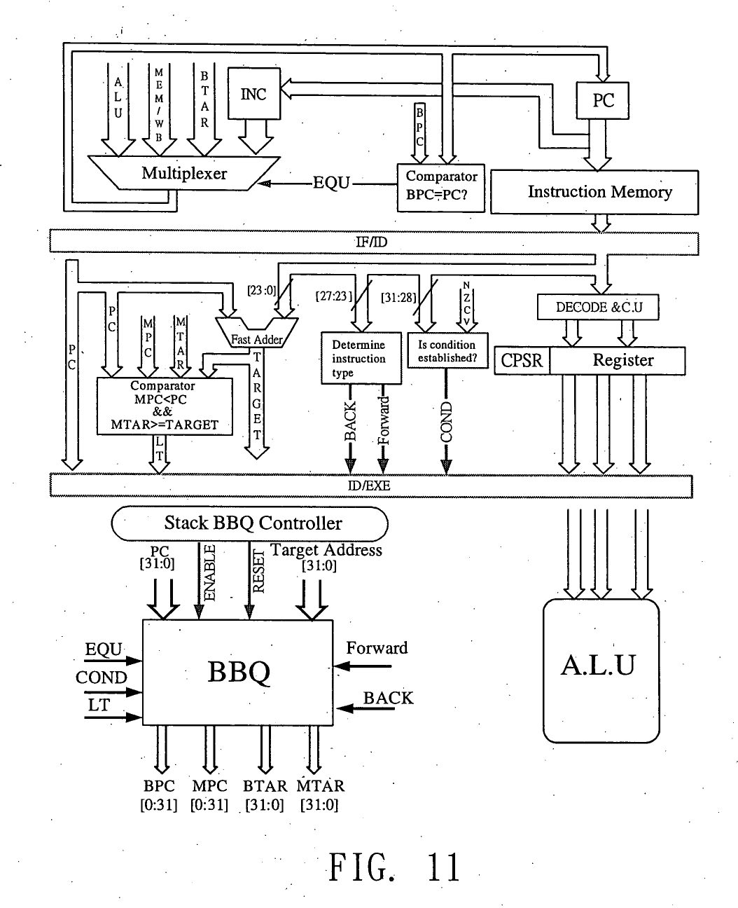

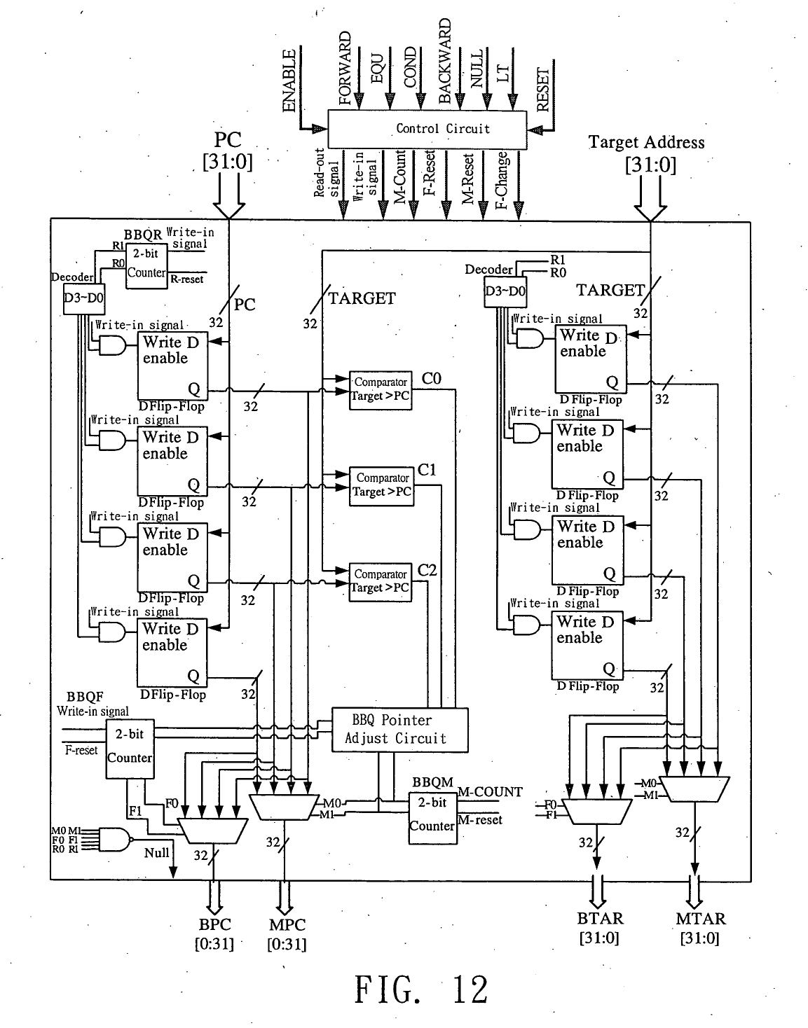

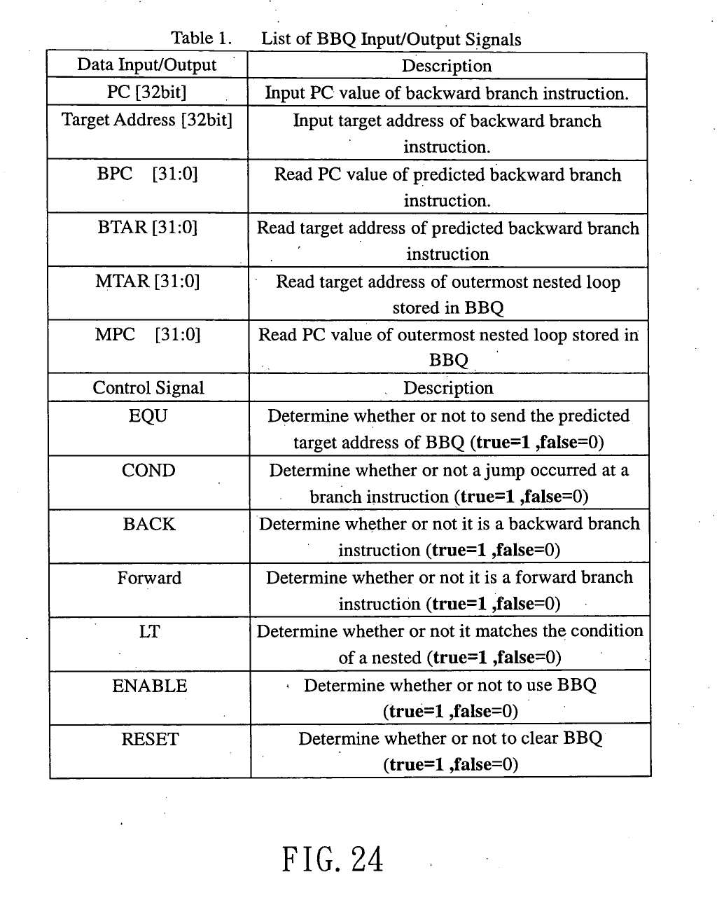

The operating mode of the BBQ is merged into the instruction pipeline flow of the processor, and its hardware circuit is used for illustrating a fifth preferred embodiment of the invention, the five-level pipeline of an ARM-9 is also used as the basic architecture, and a circuit is added to the three pipeline stages: a fetch (IF), a decode (ID) and an execution (IE) of the BBQ prediction mechanism. Firstly, a block diagram of the BBQ circuit as shown in FIG. 10 and a table of input/output and control signals as shown in FIG. 24 are provided, and described according to the three pipeline stages: fetch (IF), decode (ID) and execution (IE), and a bus with a 32-bit signal line in the BBQ circuit is used for transmitting data or control signals.

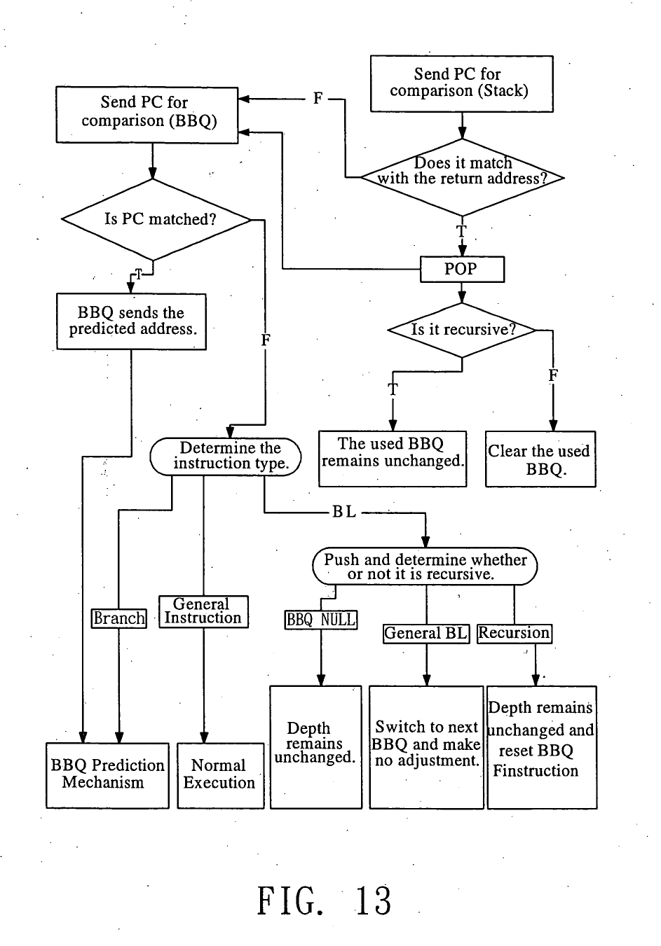

In FIG. 11, the fetch pipeline circuit at the instruction fetch stage uses a NPC multiplexer to select an address to write a next program counter (NPC) as the address for the fetch instruction at the next fetch stage. Besides selecting the original cumulative PC values from the arithmetic logic unit (ALU) and memory access, and a new data line BTAR for inputting the target address of the predicted backward branch is added to the multiplexer, such that when the BBQ circuit prediction is executed, the next fetch stage can generate the address of the predicted instruction. The fetch pipeline circuit also adds a comparator circuit for determining whether or not the PC value of the current fetch instruction is equal to the PC value of the instruction predicted by the BBQ, and a 1-bit control line EQU for determining whether or not to send out a target address predicted by the BBQ outputs the compared result to the NPC multiplexer. If the compared results are equal, then the NTC multiplexer will be controlled to send out the target address BTAR of the predicted backward branch and writes the target address BTAR back to the next program counter (NPC).

After the instruction enters into the decode stage, the decode pipeline circuit will use the [27:23] bits of a fetch instruction (and a set of data lines from the 24^{th} line to the 28^{th} line having a 32-bit signal line for the data transmission) to determine whether or not the instruction is a branch instruction and identify the type of the branch instruction such as a forward jump instruction or a backward jump instruction, and a 1-bit control signal line BACK for determining a backward jump branch instruction and a 1-bit control signal line Forward for determining a forward jump branch instruction are used to output the signals to the BBQ circuit at the execution pipeline stage; and the conditional fields of the [31:28] bits and the NZCV flag are used to determine whether or not the conditions of the instruction are established, and the 1-bit signal line COND for determining a jump of the branch instruction is outputted to the next stage and the BBQ circuit of the execution pipeline stage.

The original ARM processing branch instruction uses an ALU to compute the target address of the branch instruction only at the execution stage to prevent a delay of the pipeline occurred at the execution stage of the BBQ circuit caused by the obtaining the updated data in the BBW field after the computation made by the ALU. Therefore, the decode pipeline circuit further comprises a quick addition circuit for obtaining a target address of the branch instruction one stage in advance, and then the decode stage can determine whether or not the backward branch jump record stored in the BBQ circuit and the new backward branch constitute a nested loop or whether or not an error that will ruin the BBQ prediction mechanism occurs. The decode pipeline circuit uses a comparator t determine and read the target address MTAR of the outermost nested loop stored in the BBQ and compare the PC value MPC of the outermost nested loop stored in the BBQ with the target address and PC value of the new branch instruction, and the result determined by the comparator is sent out by a 1-bit signal line LT for determining whether or not the nested loop is matched to the BBQ circuit of at next stage for identification.

As to the ARM-9 pipeline architecture, the BBQ at the instruction decode stage adds a quick addition circuit, not only can avoid the critical path of the pipeline, but also can complete the determination of the conditions of a conditional branch instruction at the decode stage. If the address is computed in advance at the decode stage, the branch instruction can be executed, and the original two delays at the pipeline stage of the branch instruction can be reduced to one delay, and thus the branch instruction which is even not a backward branch will at most create one delay at the pipeline stage, so as to effectively reduce the delay of a pipeline of the branch instruction.

After the instruction enters into an execution stage, the BBQ circuit at the execution stage primarily selects and reads a predicted instruction according to the BBQ prediction mechanism and updates the BBQ field. The BBQ circuit in the execution pipeline circuit is divided into three sections: a BBQ storing circuit, a BBQ control circuit, and a BBQ pointer adjust circuit for the illustration as shown in FIG. 12.

This BBQ is stored in the circuit, and the storing field is comprised of two 32-bit D-type inverters for storing the PC value and target address required for recording the jump of the branch instruction, and the number of fields determines the size of number of levels in a nested loop processed by the BBQ circuit. The front pointer is read and the rear pointer is written by two counters: a BBQF counter and a BBQR counter respectively to control and select the read and write of the BBQ field, and a BBQM counter is used to select and read the last valid field stored in the BBQ field.

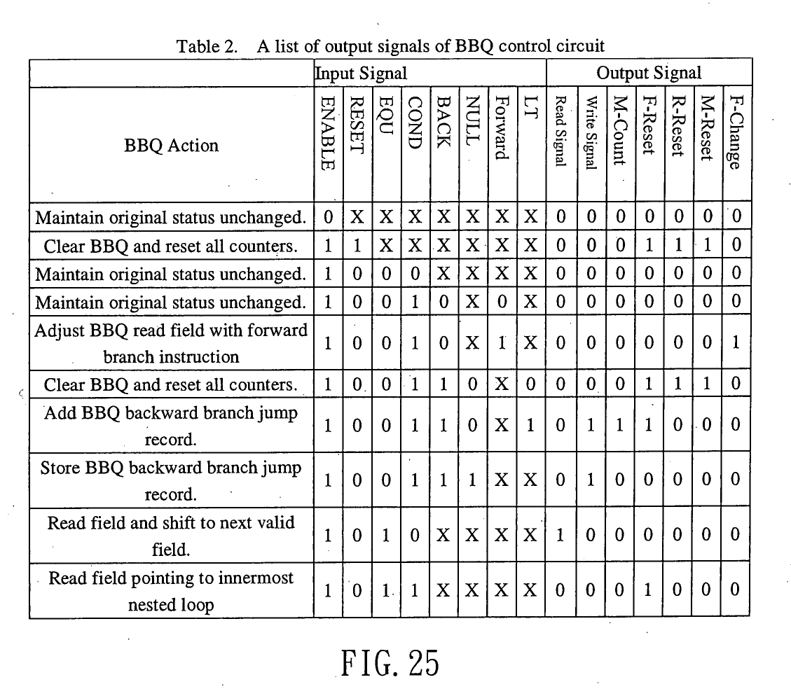

The control signals of this BBQ control circuit are listed in FIG. 25, and its main function is to control the read and write of the BBQ field, and the decode stage is used to determine an instruction at the fetch execution, so as to control the three counters: BBQF counter, BBQR counter and BBQM counter.

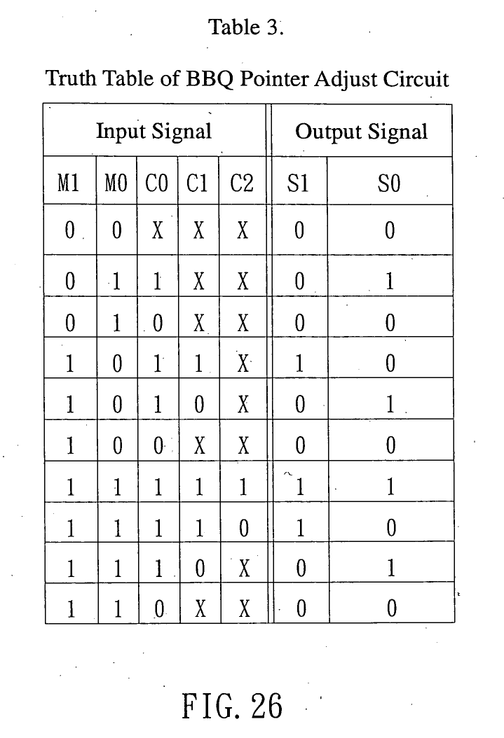

The BBQ pointer adjust circuit uses a target address of the forward branch instruction to compare with the PC value stored in each field of the current BBQ. After the determination is made by the three comparators, the results are outputted as C0, C1 and C2, and the value of the BBQM counter uses a combination logic circuit to determine the correct read pointers SI and SO as shown in FIG. 26. If the BBQF counter inputs a F-Change signal with a value of 1, then the BBQF counter will be set as the updated value for the BBQF counter according to the input values SO and S 1.

From the foregoing circuit design, the BBQ circuit is comprised of adders, latches, counters, and some small combination logics, and its hardware cost is much lower than the complicated branch target buffer (BTB) or branch prediction mechanism, and the response time of the BBQ is much faster than other prediction mechanisms.

The stacked BBQ operating mode merged into the instruction pipeline of the instructions of a processor will be described as follows. In the stacked BBQ operation flow chart as shown in FIG. 13, the left side indicates the operating flow of the original BBQ prediction mechanism and the right side indicates the control flow of the stacked BBQ. Firstly, the stacked BBQ at the instruction fetch stage uses the PC value and the return address at the top of the stack are used to compare and determine whether or not a subroutine is returned. If the returned subroutine is a recursive behavior, then the BBQ circuit will remain unchanged, or else the currently used BBQ jump record will be cleared and the program will return to the previous level of the subroutine used by the BBQ circuit. After the instruction enters into the decode stage and is determined by the decode circuit, if the instruction is a CALL instruction, the stacked BBQ will determine the behavior of the CALL subroutine. If the instruction is a recursive call, then the BBQ circuit will not be switched to the next BBQ circuit, and the record of the stack will be updated. If the instruction is a general subroutine call, then it is necessary to determine whether or not the current BBQ circuit is used. If the current BBQ circuit has not been used, then the subroutine will be called and the BBQ circuit used by the present procedure will be shared, or else the BBQ circuit will be switched to the next BBQ circuit for the independent use by the called subroutine, and the jump record of the called subroutine is pushed into the stack to wait for the return of the subroutine.

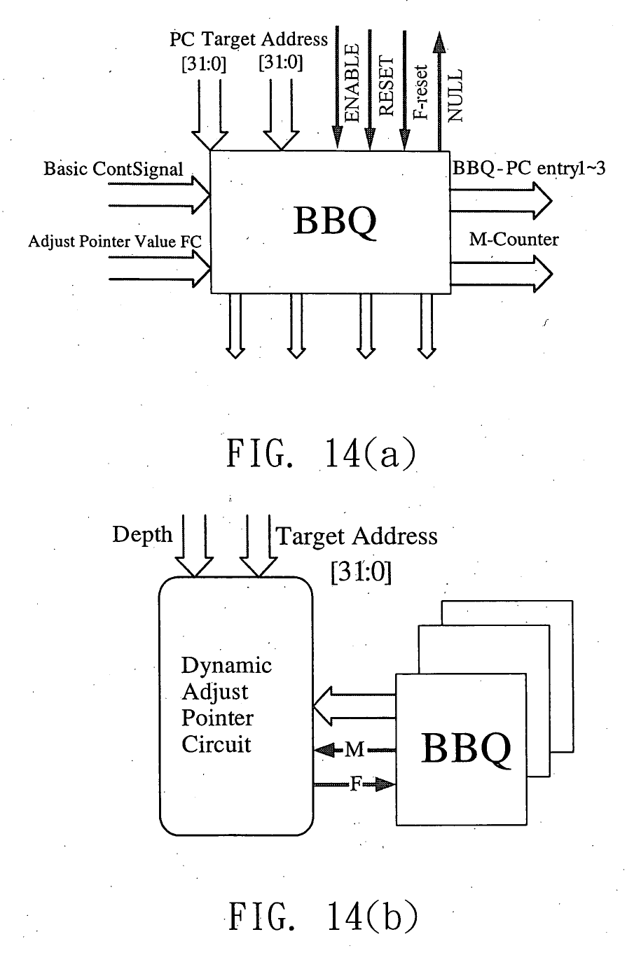

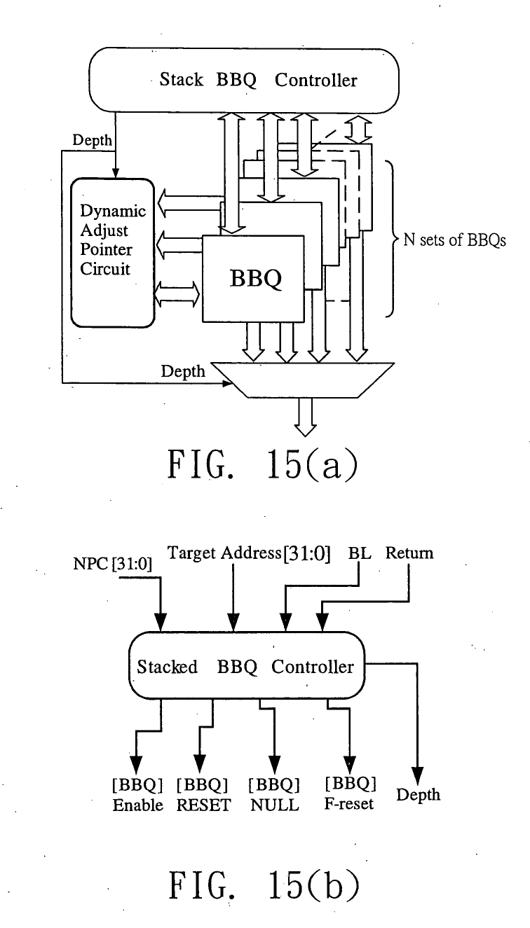

In the present design of a BBQ circuit module of a stacked BBQ architecture, a signal line Enable and a Reset signal are employed. The Enable signal controls whether or not the BBQ circuit is selected or used. If the BBQ circuit has not been selected or used then it is necessary to maintain the stored jump record and settings unchanged, and the Reset signal is controlled whether or not to clear the selected BBQ circuit. Firstly, the basic BBQ circuit is defined as shown in FIG. 14A, and the circuit for dynamically adjusting the pointer in the original BBQ circuit is provided and shared by each BBQ circuit as shown in FIG. 14B. Since the circuit for dynamically adjusting the pointer only needs to adjust the currently used BBQ circuit only, therefore the invention can reduce the burden of hardware cost.

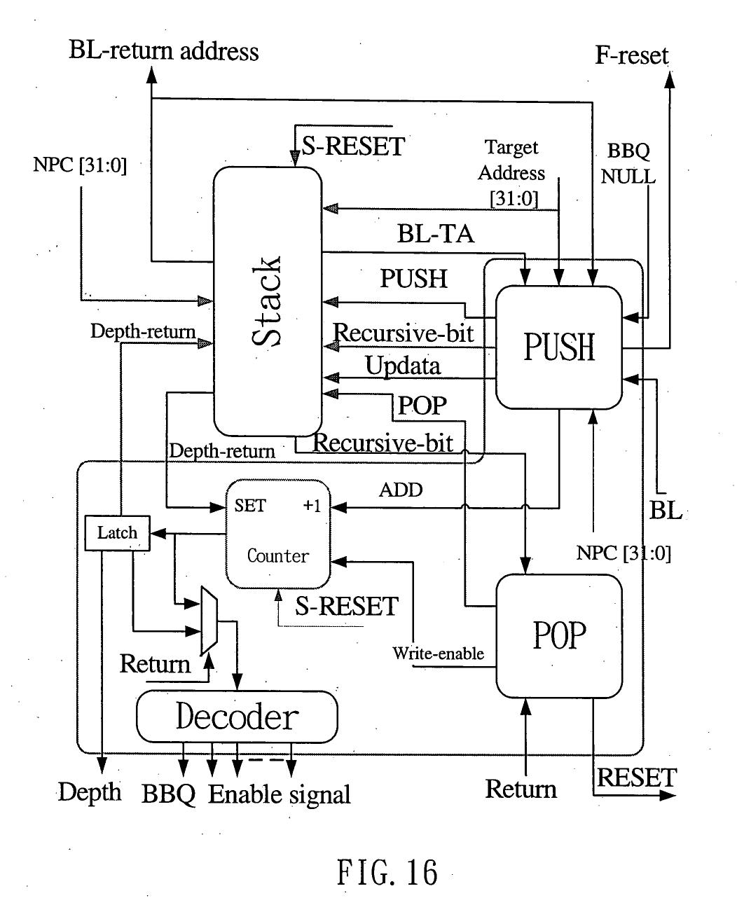

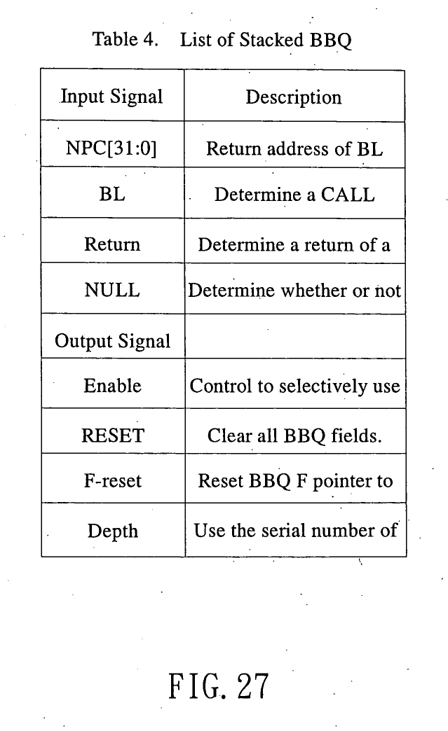

The whole design of the stacked BBQ circuit architecture as shown in FIG. 15 and FIG. 27 is used for illustrating a sixth preferred embodiment of the present invention. The whole architecture of the stacked BBQ circuit comprises a stacked BBQ controller, a dynamic pointer adjust circuit and a plurality of BBQ circuits. Its depth control signal is sent out from the stacked BBQ controller, and the main function is to control the stacked BBQ circuit to select a BBQ circuit and sends out a predicted address of the BBQ circuit and control the dynamic pointer adjust circuit to adjust the front pointer read by the currently used BBQ circuit. The stacked BBQ controller circuit comprises a stack circuit and a control circuit as shown in FIG. 16, and these two circuits will be described below.

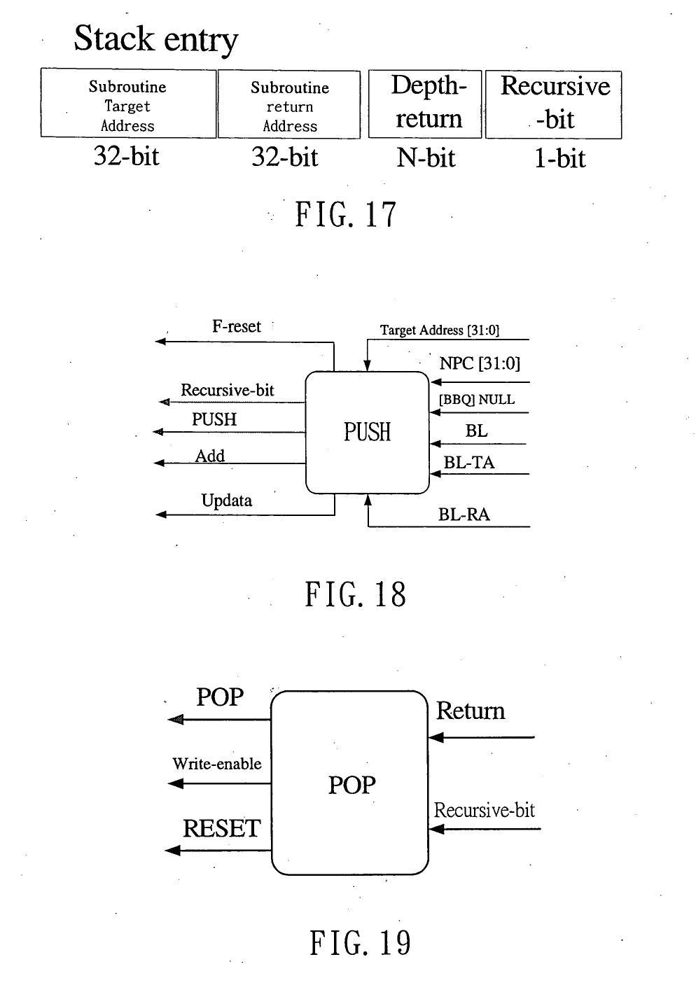

The stack circuit comprises a plurality of entries of a stack as shown in FIG. 17, and each entry stores four fields: a target address (BL-Target address) of a subroutine, a return address (BL-Return address) of a subroutine, a serial number of the BBQ circuit after a subroutine is returned (Depth-return) and whether or not the subroutine is a recursive subroutine (Recursive-bit).

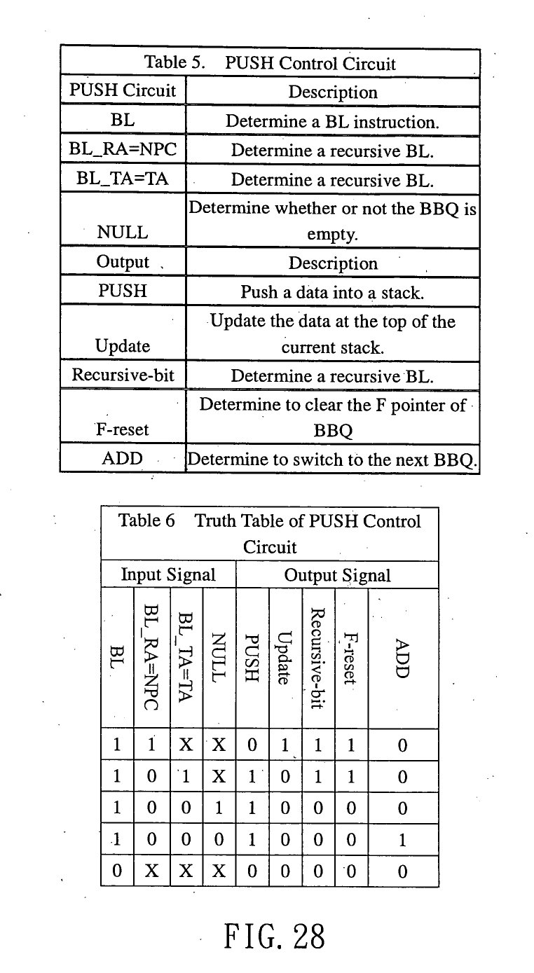

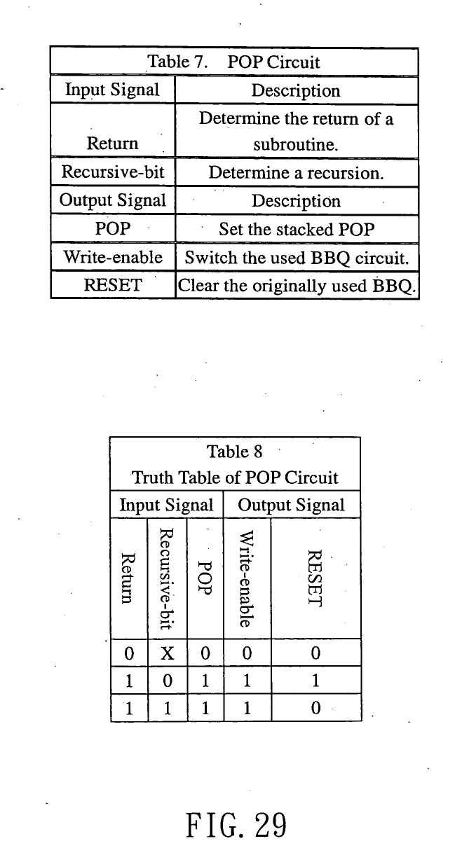

The control circuit is mainly used for determining the call/return of a subroutine and controlling the operations of a PUSH circuit and a POP circuit. The operation of the PUSH circuit is to determine a decoded instruction after a subroutine instruction BL is called. FIG. 18 shows a circuit of controlling the PUSH circuit, and the target address stored at the top of the stack is compared with the target address of the called subroutine of the call subroutine instruction BL to determine whether or not a recursion (BL_TA=Stack_TA&& LR=Stack_RA) is established. If yes, then the recursive bit stored in the stack field is set to 1, or else the recursive bit is set to 0. The call subroutine instruction BL of the called subroutine is pushed into the stack as shown in FIG. 28. FIG. 19 shows a circuit for controlling the operations of this stack POP circuit. If the PC values and address of the instruction at the instruction fetch stage are the same as those of the LR after the comparison, then a signal will be sent to control the stack to perform a POP operation. If the POP is a recursive call subroutine instruction BL, then the BBQ circuit will remain unchanged, or else the currently used BBQ circuit will be cleared and returned to the BBQ circuit used by the previous subroutine as shown in FIG. 29.

After the processor is merged into the stacked BBQ prediction mechanism, it is necessary to duplicate several sets of BBQ hardware for the use by the stacked BBQs, but the cost of a single BBQ circuit is low, and thus the overall cost and level of difficulty of the circuit will not be increased too much. Furthermore, the circuit in the stacked BBQ controller is very simple and only includes a stack circuit and simple combination logics, and thus the invention complies with the design requirements for low cost and quick response of the BBQ prediction mechanism.

To verify the effect of the BBQ prediction mechanism using a very low hardware cost to effectively overcome the performance loss caused by the control hazard and simulate and evaluate the accuracy of predicting the backward branch, we use a representative part of Mibench program as a standard performance testing program and Simplescalar simulation program as the testing platform for the evaluation and simulation. Finally, the obtained simulation data are compiled and analyzed to show the value of the BBQ prediction mechanism.

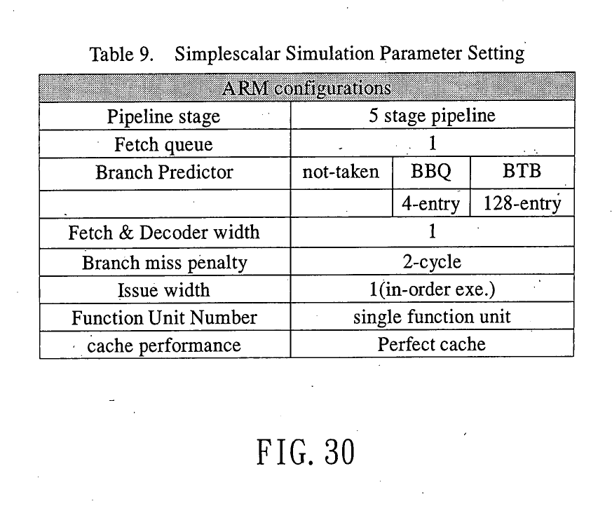

In the settings of the Simplescalar configuration, the bpred.c is added to the BBQ prediction mechanism and the 128-entry BTB architecture is built in for the performance comparison. The simulation parameters in the Sim-bpred and Sim-outorder modules are listed in FIG. 30. To assure the accuracy and reliability of the simulation evaluation, we have not modified the Benchmark or remove a section of the Benchmark program for the simulation evaluation, and no upper limit is set for the number of parameters for executing the Benchmark instructions, and thus the number of dynamic instruction executions is huge, and the simulation result can be used for evaluating the hardware performance more objectively.

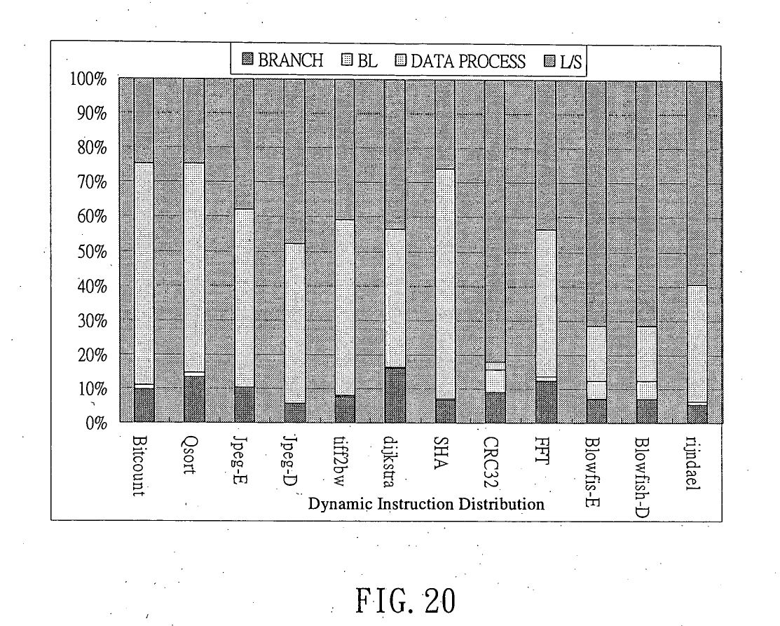

In FIG. 20, the percentages of different types of instructions among all executed instructions of the program are given. The average percentage of branch instructions is 9.15%, the average percentage of memory access instructions is 47.80%, the average percentage of data processing instructions is 41.15%, and the average percentage of subroutine call instructions is 1.90%. These simulation data are similar to those obtained from previous Mibench simulation analyses. These data show the accuracy of the simulation.

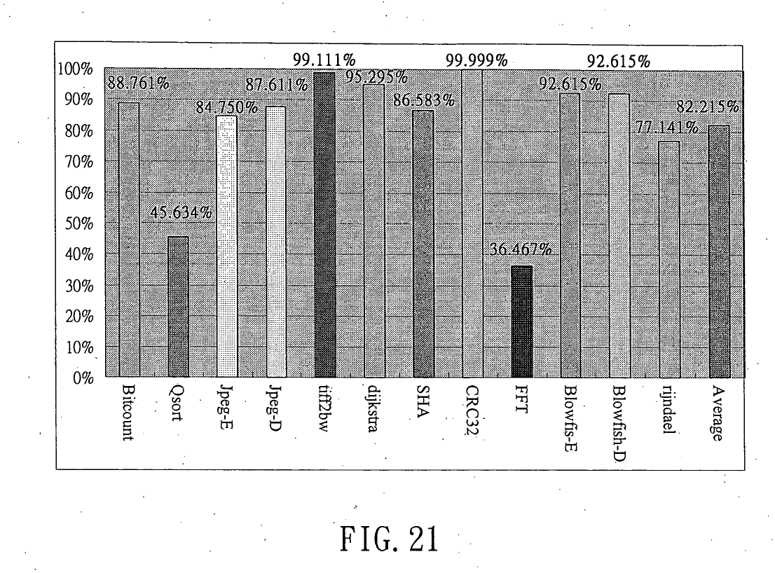

In FIG. 21, we use the sim-bpred module to simulate the BBQ prediction mechanism and predict the hit rate of the backward branch. The simulated data indicate that a high hit rate of the BBQ gives good predictions. Besides the three Benchmarks: FFT, Qsort and Rijndael give a hit rate lower than 80%, the hit rates of the prediction tested by the Qsort and FFT are low which are 45.637% and 36.467% respectively, and thus we will discuss the reasons for the lower hit rate tested by the Qsort and the FFT. For example, the loop of the Benchmarks program structure includes a subroutine instruction BL, and the subroutine for calling a subroutine instruction BL has a behavior that ruins the BBQ prediction mechanism, and thus the foregoing call subroutine instruction BL for calling a subroutine will ruin the BBQ prediction mechanism, and the Qsort has a recursive program structure that will keep on calling the subroutine to make the loss more seriously. Therefore, the percentage of sending the predicted address by the BBQ occupies only 58.27% of the total number of backward branches. Another cause resides on that if the conditions of the backward conditional branch instruction in the Qsort program are established, the occurrence of a jump only occupies 75.52% of the total number of backward branches, and thus the BBQ often sends out the predicted address. However, the conditions for the branch are not established, and thus causing failed predictions, and giving rise to a low hit rate of 45.643%. Besides the foregoing three Benchmarks that have poor hit rates, the rest of the benchmarks come with high hit rates, and the CRC32, Tiff2bw has the highest hit rate up to 99%. If the type of programs are used for distinguishing the performance of the BBQ, then the BBQ has very good average hit rates of 4.516% and 90.49% on the Network and Consumer applications respectively, and the average hit rate can reach up to 82.215%, and thus the BBQ prediction mechanism can effectively predict the backward branch, so as to reduce the control hazard caused by the pipeline and improve the processor performance.

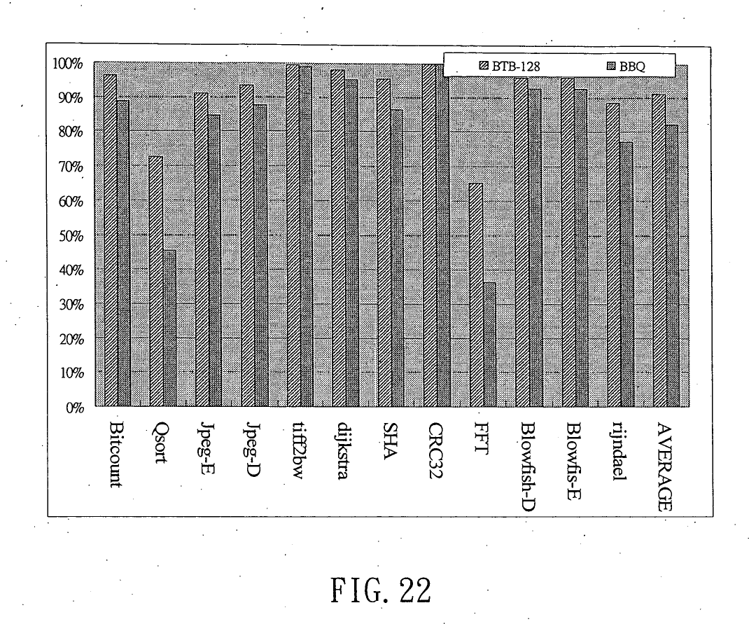

The performances of two different BTB and BBQ branch predictions are compared as shown in FIG. 22, and we use the BTB architecture of the XScale for setting the BTB as the architecture for comparing the BBQ and use the hit rate for predicting the backward branch in the simulation for the comparison. Although the BBQ performance is not superior to the BTB, the performance of the BTB and BBQ are not good enough and the hit rates of other Benchmark are very close to those of the BBQ and BTB, and the hit rates of the BBQ and BTB in the Tiff2bw and the CRC32 are almost the same. As to the overall average hit rate, the BBQ only uses a simple control structure and four entries to achieve the hit rate of 90.35% for the 128-entry BTB. The simulated results show that the BBQ can use a simple hardware to achieve a BTB performance over 90% which also show the effectiveness of the BBQ design of the invention.

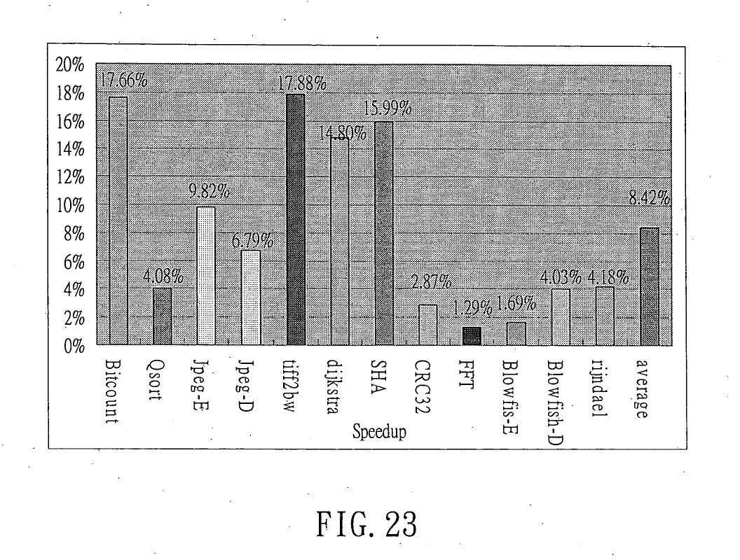

For the evaluation of the overall performance, we selected the ARM-9 as the base for the comparison and added the simulated evaluation to the BBQ prediction mechanism to improve the performance as shown in FIG. 23. Although a vast majority of the Benchmarks have a hit rate over 80%, yet not all Benchmarks show a drastic increase of performance. We will use CRC32 as an example for the illustration. The hit rate of the CRC32 is up to 99.99% and the performance is improved by 2.87% because the backward branches only occupy 2.2% of the total number of executed instructions, but the Load/Store instructions occupy 82.21%. Therefore, the BBQ can improve the effect on the pipeline of the backward branch. Since the backward branches occupy a small percentage of the total number of the executed instructions and the performance can be only improved to a very limited extent. However, the backward branches in Bitcount, tiff2bw, dijkstra, and SHA occupy a higher percentage of the total number of executed instructions, and these percentages are 8.08%, 7.64, 6.41% and 6.45% respectively, and the hit rate of the BBQ prediction mechanism is also more than 80%, and thus a performance improvement of more than 10% can be achieved, and the average performance of all Benchmarks can be improved by more than 8.42%.

From the foregoing simulation evaluation, we discovered that the BBQ structure not only gives a simple structure only, but provides a prediction accuracy over 90% for most benchmarks. In these simulation data, we also discovered that the BBQ can further improve over the prior art. The program behavior analyses of the Qsort and the FFT show that the BBQ can effectively identify the program call/return, and thus the stacked BBQ mechanism can avoid a prediction contamination effect between the main program and subroutines, so as to further improve the overall prediction accuracy.

In summation of the description above, the present invention has the following advantages:

Firstly, the level of complexity of hardware of the BBQ circuit according to the present invention is very low, and the hardware of the BBQ circuit of the invention emphasizes on the hardware architecture of a microprocessor and adopts a maximum execution frequency to define a behavior or a mode of the backward branch. Since the backward branch comes with specific behaviors and often appears in form of a nested loop in the program structure. Based on these behaviors and structural characteristics, a simple and effective branch prediction mechanism is used to overcome the control hazard caused by the pipeline execution of instructions of this sort, and this mechanism is a backward branch prediction queues (BBQ) design, and thus the level of complexity of the hardware of the BBQ circuit is very low. With the pipeline execution, a prediction can be achieved at the first fetch stage.

Secondly, the present invention is applicable for an embedded processor with a low cost and a simple structure. Since the BBQ structure needs not to store too many instructions or quickly compare a large number of data by the associative memory technique, therefore the features of simple hardware, low cost and simple structure of the present invention are very suitable for the application of embedded processors.

Thirdly, the BBQ mechanism of the invention can be used together with other branch control hazard technologies, and the BBQ also can be used together with other branch control hazard technologies. For instance, a predicated execution technology can be used, such that the BBQ performs a backward branch prediction, and uses a predicated execution method to remove a vast majority of the forward branch instructions or works with the hardware of the branch target buffer (BTB), such that the BBQ performs a backward branch prediction, and the BTB stores and predicts the forward branch instruction. Based on the current simulation and performance verification, it is found that such combination can achieve a prediction efficiency approximately equal to twice the capacity of the BTB.

What is claimed is:

1. A programmable backward jump instruction prediction mechanism, including a backward branch prediction queues (BBQ);
when a program starts executing a nested loop, said BBQ determines a program counter (PC) value of an innermost backward branch according to a target address of said innermost backward branch and the size of said program counter (PC) and stores said target address into said BBQ, such that if the same innermost loop is executed later, then said BBQ will be able to read a front pointer to locate a correct predicted address;
when said program executes a next level said backward branch, said target address is situated in front of the target address of said innermost backward branch, and the PC value of said next level backward branch is greater than the PC value of said innermost backward branch, and said next level backward branch is stored into said BBQ;
since said next level backward branch will jump back for an iteration, therefore the front pointer read by said BBQ will be reset to zero, and said pointer value is zero, and a jump information is pointed at an innermost backward instruction stored in said BBQ, such that said innermost loop can quickly provide the address of said innermost backward branch until the last jump prediction fails, and then said front pointer will enter into the next address to adjust the next prediction for said level of backward branch;
after said next level backward branch successfully predicts the execution of said level of loop, the front pointer read by said BBQ will be returned automatically to the execution of said innermost backward branch to repeated the foregoing process; a BBQ field records the status of each loop according to the number of levels of said backward branch, and said status will be maintained until the no backward jump remains in a loop execution (and thus causing an error to the back jump of a next level backward branch backward jump);
said loop status stored in said BBQ field will be changed alternately in any situation of each level of said loop and continuously remains no jump for the execution of said outermost loop, and by then said BBQ prediction fails and prepares to exit said nested loop, but the content in a BBQ field will not be cleared at the time being, but will get ready to add another outer nested loop;
if an execution encounters said other outer backward branch at a later time, and said BBQ discovers an unmatched condition, and thus the target address (of said other outer backward branch) is greater than the target address (of said outermost backward branch) and the PC value of (said other outer backward branch) is smaller than the PC value (of said outermost backward branch), and said BBQ is cleared, and said other outer backward branch is stored in said BBQ, and similar to the situation of returning to said BBQ and storing the PC value of said innermost backward branch and the target address into said BBQ.

2. The programmable backward jump instruction prediction mechanism of claim 1, wherein said if a forward branch instruction exists in said nested loop, and said target address of said forward branch instruction exists in said nested loop, and the PC value of said forward branch instruction and said target address jumps over said innermost backward branch of said innermost loop of said nested loop, said BBQ will determine whether or not the jump of the target address of said forward branch instruction is greater than the address of the predicted PC value, according to the target address of said forward branch instruction jump and the jump information recorded in said current BBQ field and by using a comparator for the comparison; if yes, then said BBQ will locate the address of a predicted PC value of the next effective field and its target address, and then said comparator determines a result until said result is not greater than the current status, and dynamically reads said front pointer that points at an effective field of said BBQ and sends out a correct predicted address; otherwise, said BBQ remains unchanged.

3. The programmable backward jump instruction prediction mechanism of claim 1, wherein said program comprises a main program and a subroutine having a depth equal to two, and said main program has a main program loop, and said main program loop further has a main program backward branch and a branch instruction for calling a first depth subroutine disposed at the level of said main program loop, and said first depth subroutine has a first depth subroutine loop, and said first depth subroutine further has a backward branch of said first depth subroutine, and a branch instruction for calling said second depth subroutine disposed at said main program loop;
said prediction mechanism further comprises a plurality of BBQs to define a stacked backward branch prediction queue (stacked BBQ) for said main program to use said BBQ independently, and said first depth subroutine uses said second BBQ independently, and said second depth subroutine uses said third BBQ independently; and a stack circuit for storing the information of continuously calling/returning said each depth subroutine and controlling the switch between said BBQs;
if a branch instruction for calling said first depth subroutine calls said first depth subroutine in the execution of an application program, said stacked BBQ will record and push said branch instruction into said stack circuit, and control the switch of the currently used first BBQ to the next and second BBQ, and the originally used first BBQ is kept in the original field and remains unchanged; if said first depth subroutine has not been returned, and said branch instruction for calling said first depth subroutine to continuously call said second depth subroutine, and similarly said branch instruction for calling said second depth subroutine is pushed into said stack circuit for switching said second BBQ to the next and third BBQ; if said branch instruction for calling said second depth subroutine is returned, then said branch instruction for calling second depth subroutine branch instruction will pop out from said stack circuit and switch to return to said second BBQ; so as to effectively prevent affecting the accuracy of predicting a single BBQ caused by an interference between said main program and said first depth subroutine and between said first depth subroutine and said second depth subroutine.

4. The programmable backward jump instruction prediction mechanism of claim 1, wherein said program comprises a main program and a plurality of subroutines; and said main program is a nested loop, and a subroutine branch instruction for calling one of said subroutines is situated in said nested loop of said main program nested loop; and said subroutine also includes a subroutine branch instruction for calling another subroutine; and said each subroutine could have a nested loop;
said prediction mechanism further comprises a plurality of BBQs to form a stacked backward branch prediction queue (stacked BBQ) provided for said main program to use a BBQ independently, and said each subroutine independently uses said BBQ; and a stack circuit is provided for storing the information of continuously calling/returning said each subroutine and controlling the switch between said BBQs;
if a stacked BBQ prediction mechanism that has not started calling a subroutine in a program execution selects to use a BBQ and said BBQ stores a jump record of a backward branch of said main program and a subroutine is called, and since said subroutine stored in said BBQ will use said jump record again when said subroutine is returned, therefore said BBQ is switched to another BBQ provided for the use of said subroutine, and said jump record of said subroutine, said return address and a serial number of said currently used other BBQ are pushed into the record of said stack circuit; and after said subroutine is entered, and said subroutine has not used said other jump record of said subroutine backward branch stored in said BBQ, such that when said subroutine calls another subroutine, said other BBQ will be situated at an unused status, and then said stacked BBQ just pushes a record of calling said other subroutine into said stack circuit, not only switching said BBQ to said other BBQ, but also using the same BBQ (and said other BBQ) provided for the use of said other subroutine to reduce the number of BBQs used; when said other subroutine is returned, said stacked BBQ will clear said jump record stored in said currently used other BBQ and pop out said record at the top of said stack circuit, and said BBQ serial number according to said subroutine recorded by said stack circuit is used for switching to a corresponding BBQ, and if another subroutine is not called, then said stacked BBQ will be operated similarly to switch said BBQ to another BBQ until said subroutine is returned.

5. A circuit of a programmable backward jump instruction prediction mechanism, being a backward branch prediction queues (BBQ) circuit including a backward branch prediction queues (BBQ) prediction mechanism, and a multi-stage pipeline of an advanced RISC machine (ARM) processor used as a basic architecture, and operating with said BBQ prediction mechanism that installs a fetch pipeline circuit, a decode pipeline circuit and an execution pipeline circuit at three pipeline stages including a fetch (IF), a decode (ID) and an execution (IE) respectively; and a 32-bit signal line bus is used in said BBQ circuit for transmitting data or control signals;
if an instruction enters into a fetch stage, said fetch pipeline circuit uses a NTC multiplexer to select an address and write a next program counter (NPC) as an address used for a next fetch stage fetch instruction; said NTC multiplexer accepts the input from an arithmetic logic unit (ALU), a memory access, a cumulative value of PC and a new added data line for reading and predicting the target address of said backward branch, such that when said BBQ circuit provides a nest fetch stage for a prediction execution, the address of said prediction instruction will be generated; said fetch pipeline circuit further comprises a compare circuit for comparing and determining whether the PC value of said current fetch instruction is equal to the PC value of said BBQ circuit prediction instruction, and uses a 1-bit control line for determining whether or not to send out the target address of a BBQ prediction to output said compared result to said NPC multiplexer, if both PC values are equal, then said NPC multiplexer is controlled to send out the target address of a read predicted backward branch and write back said next program counter (NPC);
after said instruction enters into a decode stage, said decode pipeline circuit will use [27:23] bits of a fetch instruction to determine whether or not said instruction is a branch instruction and identify the type of said branch instruction including a forward jump instruction or a backward jump instruction, and uses a 1-bit control signal line for determining a backward jump branch instruction and a 1-bit control signal line for determining a forward jump branch instruction control to output a signal to said BBQ circuit at an execution pipeline stage; and obtains [31:28] bit condition field and a NZCV flag to determine whether or not the condition of said instruction is established and output said determined result that uses a 1-bit signal line to output a jump of said branch instruction to a next stage and a BBQ circuit at said execution pipeline stage;
wherein said decode pipeline circuit further comprises a quick addition circuit for obtaining a target address of said branch instruction in one stage in advance, so as to determine whether or not a jump record of said backward branch stored in said BBQ circuit in advance and a new backward branch constitute a nested loop, or whether or not an error that ruins said BBQ prediction mechanism is produced; said decode pipeline circuit uses a comparator to determine a target address of said outermost nested loop stored in said read front BBQ and reads the PC values of said nested loop outermost stored in said BBQ and a target address and a PC value of a new branch instruction for a comparison, and a result determined by said comparator is outputted by using a 1-bit signal line for determining the match of a nested loop to said BBQ circuit at a next stage for identification;
after said instruction enters into an execution stage, said execution pipeline circuit selects and reads said predicted instruction and updates said BBQ field according to said BBQ prediction mechanism.

6. The circuit of a programmable backward jump instruction prediction mechanism of claim 5, wherein said execution pipeline circuit further comprises:
a BBQ storing circuit, having a storing field comprised of two 32-bit D-type inverters, for separately storing a PC value and a target address required for recording a jump of a branch instruction, and the number of fields determines the size of number of levels of a nested loop processed by said BBQ circuit; reading a front pointer and writing a rear pointer by a BBQF counter and a BBQR counter for controlling and selecting a read or a write of a BBQ field, and using a BBQM counter to select and read a last valid field stored in said BBQ field;
a BBQ control circuit, for controlling a read and a write of said BBQ field, and determining an instruction at a fetch execution according to a decode stage to control said BBQF counter, said BBQR counter and said BBQM counter;
a BBQ pointer adjust circuit, using a target address of a forward branch instruction and each PC value in a current BBQ storing field for comparing their magnitude, and the result obtained after the determination by three comparators is outputted as C0, C1, and C2, and the value of said BBQM counter, and a combination logic circuit is used for determining correct read values of front pointers S1 and S0, and if said BBQF counter inputs a F-Change signal equal to 1, said BBQF counter will be set to a value changed by said BBQF counter according to said set values S0 and S1.

7. The circuit of a programmable backward jump instruction prediction mechanism of claim 5, further comprising a stacked BBQ controller, a dynamic pointer adjust circuit, a plurality of BBQ circuits to form a stacked backward branch prediction queue (Stacked BBQ) circuit; wherein said stacked BBQ controller will send out a depth control signal for controlling said stacked BBQ circuit to select a BBQ circuit and sending out a predicted address of said BBQ circuit, and control said dynamic pointer adjust circuit to adjust the currently used front pointer of said BBQ circuit.

8. The circuit of a programmable backward jump instruction prediction mechanism of claim 7, wherein said stacked BBQ controller further comprises a stack circuit and a control circuit.

9. The circuit of a programmable backward jump instruction prediction mechanism of claim 8, wherein said stack circuit has a plurality of entries of a stack, and said each entry stores the four fields including the target address of a call subroutine, the return address of a subroutine, the serial number of said BBQ circuit after said subroutine returns and a determination of whether or not said routine is recursive.

10. The circuit of a programmable backward jump instruction prediction mechanism of claim 8, wherein said control circuit determines a call/return of subroutine and controls the operation of a PUSH circuit and a POP circuit.

11. The circuit of a programmable backward jump instruction prediction mechanism of claim 10, wherein said PUSH circuit is operated to control said PUSH circuit, and after said instruction determines an instruction for calling a subroutine instruction by decoding, said PUSH circuit is controlled to compare the current target address stored at the top of a stack with the target address of a subroutine for calling said subroutine instruction and determine whether or not an iteration (BL_TA=Stack_TA&& LR=Stack_RA) is established; if yes, then the logical value for the recursive behavior stored in a setup stack field will be set to 1, or else the logical value will be set to 0, and said subroutine instruction for calling said subroutine is pushed into said stack;
if said instruction is situated at an instruction fetch stage and the address of said compared PC value is equal to the LR value, a signal will be issued for controlling a stacked POP operation; if the recursive behavior of POP is an instruction for calling a subroutine, then said BBQ circuit remains unchanged, or else said currently used BBQ circuit will be cleared and returned to a BBQ circuit used for a previous subroutine.
